(19) United States
(12) Patent Application Publication
(10) Pub. No.: US 2026/0365173 A1
(43) Pub. Date: Nov. 19, 2026

(54) VEHICLE CONTROL DEVICE, VEHICLE CONTROL METHOD AND NON-TRANSITORY COMPUTER READABLE STORAGE MEDIUM

(71) Applicant: DENSO CORPORATION, Kariya-city (JP)

(72) Inventors: Takeshi HATO, Kariya-city (JP); Kodai TAKEDA, Kariya-city (JP); Hiroshi UCHIGASHIMA, Kariya-city (JP); Noriyasu NOTO, Kariya-city (JP); Masahiro TAKAHASHI, Kariya-city (JP)

(21) Appl. No.: 19/723,220

(22) Filed: Jun. 29, 2026

Related U.S. Application Data
(63) Continuation of application No. PCT/JP2024/042492, filed on Dec. 2, 2024.

(30) Foreign Application Priority Data
Feb. 1, 2024 (JP) 2024-014410

(51) Int. Cl. B60W 30/18; B60W 50/14

(52) U.S. Cl. CPC B60W 30/18159; B60W 50/14; B60W 2420/403

(57) ABSTRACT

A vehicle control device controls at least one external camera that captures an image of a periphery area of a vehicle. The vehicle control device includes: a position grasp unit that grasps a positional relationship between an intersection and the vehicle when the vehicle plans to turn right or left at the intersection; and a recognition control unit that changes a state of at least one high-precision recognition range, which is recognized with higher accuracy than a normal recognition range within an image capturing area captured by the at least one external camera, depending on the positional relationship.

### CROSS REFERENCE TO RELATED APPLICATION

The present application is a continuation application of International Patent Application No. PCT/JP2024/042492 filed on Dec. 2, 2024, which designated the U.S. and claims the benefit of priority from Japanese Patent Application No. 2024-014410 filed on Feb. 1, 2024. The entire disclosures of all of the above applications are incorporated herein by reference.

### TECHNICAL FIELD

The disclosure of this specification relates to a control technique for a vehicle that controls an external camera for capturing an image of the periphery of the vehicle.

### BACKGROUND

A conceivable technique teaches an image processing device that is mounted on a vehicle as a moving device and includes an imaging unit that captures an image of the area behind the vehicle. When the vehicle merges into another traffic lane, this image processing device changes the position of a high-resolution area set in part of the image captured by the imaging unit depending on the positional relationship between the destination traffic lane and the vehicle.

### SUMMARY

According to an example, a vehicle control device controls at least one external camera that captures an image of a periphery area of a vehicle. The vehicle control device includes: at least one of (i) a circuit and (ii) a processor with a memory storing computer program code executable by the processor. The at least one of the circuit and the processor may be configured to cause the vehicle control device to execute: grasping a positional relationship between an intersection and the vehicle when the vehicle plans to turn right or left at the intersection; and changing a state of at least one high-precision recognition range, which is recognized with higher accuracy than a normal recognition range within an image capturing area captured by the at least one external camera, depending on the positional relationship.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an overall view of an in-vehicle system including a periphery monitoring ECU according to a first embodiment of the present disclosure;

FIG. 2 is a diagram showing an example of a plurality of external cameras mounted on a vehicle;

FIG. 3 is a block diagram showing details of a periphery monitoring ECU and an autonomous driving ECU together with related configurations;

FIG. 4 is a diagram showing an example of an imaging area photographed by a front telephoto camera;

FIG. 5 is a diagram showing the setting of a high-precision recognition range in a scene where a subject vehicle turns right although there is an oncoming vehicle;

FIG. 6 is a diagram showing the setting of a high-accuracy recognition range in a scene where a subject vehicle turns right although there is a preceding vehicle;

FIG. 7 is a diagram showing the setting of a high-precision recognition range within an intersection area;

FIG. 8 is a diagram showing the setting of a high-precision recognition range after exiting an intersection;

FIG. 9 is a diagram showing the setting of a high-accuracy recognition range before entering an intersection n a scene where a subject vehicle turns left;

FIG. 10 is a diagram showing the setting of a high-accuracy recognition range within an intersection area;

FIG. 11 is a diagram for explaining a scene of turning right or left at a series of intersections;

FIG. 12 is a diagram for explaining a scene of turning right or left at a series of intersections;

FIG. 13 is a flowchart showing details of a pattern setting process executed by the periphery monitoring ECU;

FIG. 14 is a flowchart showing details of a high-accuracy range control process for a right turn pattern together with FIG. 15;

FIG. 15 is a flowchart showing details of a high-accuracy range control process for a right turn pattern together with FIG. 14;

FIG. 16 is a flowchart showing details of a high-accuracy range control process for a left turn pattern;

FIG. 17 is a block diagram showing details of a periphery monitoring ECU according to a second embodiment of the present disclosure together with related configurations; and

FIG. 18 is a diagram for explaining the operation of adjusting the direction of the front telescope camera by the variable mechanism.

### DETAILED DESCRIPTION

While the conceivable technique teaches a control for changing the position of the high-resolution area when changing a traffic lane, it does not teach a control at an intersection. Therefore, there is a concern that the high-resolution area may not be set properly in a scene where the vehicle is turning right or left at an intersection.

The present embodiments aim to provide a vehicle control device and a vehicle control method that are capable of properly sensing the environment around the vehicle using an external camera when the vehicle is turning right or left turn at an intersection.

In order to achieve the above object, one aspect of the present embodiments is a vehicle control device that controls at least one external camera that captures an image of a periphery area of a vehicle. The vehicle control device includes: a position grasp unit that grasps a positional relationship between the intersection and the vehicle when the vehicle is to turn right or left at the intersection; a recognition control unit that changes the condition of a high-precision recognition range, which is recognized with higher accuracy than other normal recognition ranges within the imaging area captured by the external camera, depending on the positional relationship.

Another aspect of the present embodiments is a vehicle control method for controlling at least one external camera that captures an image of a periphery area of a vehicle. The vehicle control method provides a process executed by at least one processing unit. The process includes: grasping a positional relationship between the intersection and the vehicle when the vehicle is to turn right or left at the intersection; changing the condition of a high-precision recognition range, which is recognized with higher accuracy than other normal recognition ranges within the imaging area captured by the external camera, depending on the positional relationship.

In these aspects, when the subject vehicle is turning right or left at an intersection, the condition of the high-accuracy recognition range in which a device of the vehicle recognizes with high accuracy is changed according to the positional relationship between the intersection and the subject vehicle. Therefore, when turning right or left at an intersection, it becomes possible to properly sense the environment around the subject vehicle using an external camera.

The reference numerals in the parentheses in features are just examples of the correspondence with the specific components in the embodiments, and do not limit the scope of the present disclosure. In addition, combinations of claims that are not explicitly stated in claims by dependency are also included in a scope of the present disclosure unless there is a particular difficulty existing in the combination.

The following will describe embodiments of the present disclosure with reference to accompanying drawings. In the following description, the same reference symbols are assigned to corresponding components in each embodiment in order to avoid repetitive descriptions. In each of the embodiments, when only a part of the configuration is described, the remaining parts of the configuration may adopt corresponding parts of other embodiments. Further, not only the combinations of the configurations explicitly shown in the description of the respective embodiments, but also the configurations of multiple embodiments can be partially combined even when they are not explicitly shown as long as there is no difficulty in the combination in particular.

### First Embodiment

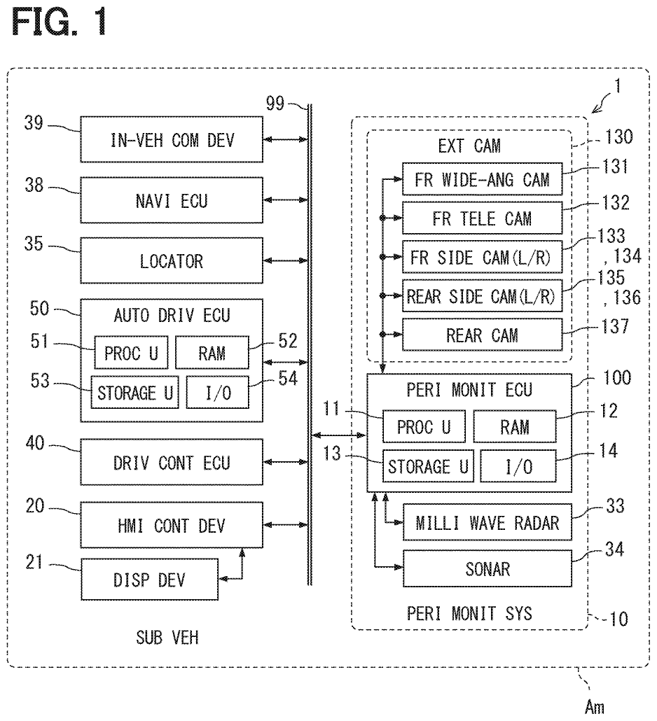

The functions of the vehicle control device according to the first embodiment of the present disclosure are realized by a periphery monitoring ECU (Electronic Control Unit) 100 shown in FIG. 1. The periphery monitoring ECU 100 is mounted on a vehicle (hereinafter referred to as the subject vehicle Am) together with the autonomous driving ECU 50. By mounting the periphery monitoring ECU 100 and the autonomous driving ECU 50, the subject vehicle Am becomes an autonomous driving vehicle or an automatic driving vehicle equipped with an autonomous driving function. The autonomous driving ECU 50 is configured to be able to implement at least an autonomous driving function (or driving support function) equivalent to autonomous driving level 2. The autonomous driving ECU 50 may be configured to be capable of realizing the autonomous driving function of the autonomous driving level 3 or higher.

The autonomous driving level in this disclosure is defined based on standards established by the Society of Automotive Engineers in the US. The autonomous driving at Level 2 is an autonomous driving (i.e., an eyes-on autonomous driving) that requires a driver to visually monitor the periphery of the subject vehicle and requires a periphery monitoring obligation. The autonomous driving at Level 2 includes hands-on autonomous driving in which the driver is obliged to grip the steering wheel and hands-off autonomous driving in which the driver is not obliged to grip the steering wheel.

The autonomous driving at Level 3 is an eyes-off autonomous driving in which the monitoring around the subject vehicle is unnecessary and there is no periphery monitoring obligation. The autonomous driving ECU 50 may be capable of performing fully autonomous driving at Level 4 in which the system performs all driving tasks under certain conditions, and fully autonomous driving at Level 5 in which the system performs all driving tasks under all conditions. The autonomous driving at Level 4 is brain-off autonomous driving in which a request for a driver to take over a driving operation does not substantially occur. The autonomous driving at Level 5 is driverless autonomous driving that does not require a driver to get on.

(Configuration of in-Vehicle System)

The periphery monitoring ECU 100 and the autonomous driving ECU 50 are elements that constitute the in-vehicle system of the subject vehicle Am, and are communicably connected to a communication bus 99 of the in-vehicle network 1 mounted in the subject vehicle Am. The communication bus 99 is further connected to a locator 35, a navigation ECU 38, an in-vehicle communication device 39, a driving control ECU 40, an HMI (Human Machine Interface) control device 20, and the like. The nodes connected to the communication bus 99 can communicate with one another. Specific nodes connected to the communication bus 99 may be electrically connected directly to each other and may be able to communicate without using the communication bus 99.

The locator 35 includes a GNSS (global navigation satellite systems) receiver, an inertial sensor, and the like. The locator 35 combines positioning signals received by the GNSS receiver from multiple positioning satellites, measurement result of an inertial sensor, vehicle speed information output to the communication bus 99, and the like, and successively measures a position and a travelling direction of the subject vehicle Am. The locator 35 sequentially outputs, as locator information, the position information and direction information of the subject vehicle Am based on a positioning result to the communication bus 99.

The locator 35 further includes a map database (hereinafter, referred to as map DB) that stores map data. The map DB mainly includes a large capacity storage medium for storing a large number of pieces of three-dimensional map data and two-dimensional map data. The three-dimensional map data is also known as high definition (HD) map, and includes road information necessary for the autonomous driving control. The locator 35 reads out the map data of the area around the current position of the subject vehicle from the map DB and provides the map data to the navigation ECU 38, the autonomous driving ECU 50, the periphery monitoring ECU 100, and the like together with the locator information.

The navigation ECU 38 acquires information of a destination designated by an occupant such as a driver of the vehicle based on operation information acquired from the HMI control device 20. The navigation ECU 38 acquires the subject vehicle position information and the direction information from the locator 35 and sets a route from the current position to the destination. The navigation ECU 38 provides route information indicating the set route to the destination to the autonomous driving ECU 50, the HMI control device 20, and the like. The navigation ECU 38 cooperates with the HMI control device 20, combines screen display, voice messages, and the like as route guidance to the destination, and notifies the driver of the traveling direction of the subject vehicle Am at an intersection, a branch point, and the like.

Here, a user terminal such as a smartphone may be connected to the in-vehicle network 1 or the HMI control device 20. Such a user terminal may provide information on the subject vehicle position, the direction information, and the map data to the autonomous driving ECU 50, and the like in place of the locator 35. Furthermore, the user terminal may provide the route information to the destination to the HMI control device 20, the autonomous driving ECU 50, the periphery monitoring ECU 100, and the like instead of the navigation ECU 38.

The in-vehicle communication device 39 is an in-vehicle external communication device mounted on the subject vehicle Am. The in-vehicle communication device 39 functions as a Vehicle to Everything (V2X) communication device. The in-vehicle communication device 39 transmits and receives information to and from a roadside device installed beside the road and another vehicle around the subject vehicle by wireless communication. As an example, the in-vehicle communication device 39 receives congestion information, traffic restriction information, and the like around the current position and in the traveling direction of the subject vehicle Am from a roadside device. The congestion information and the traffic restriction information is, for example, VICS (registered trademark) information. Furthermore, the in-vehicle communication device 39 may receive target detection information acquired by the roadside device and other vehicles.

The drive control ECU 40 is an electronic control unit including a microcontroller as its main component. The drive control ECU 40 generates vehicle speed information indicating the current traveling speed of the subject vehicle Am based on a detection signal of a wheel speed sensor mounted to a hub portion of each wheel, and sequentially outputs the generated vehicle speed information to the communication bus 99. The drive control ECU 40 has at least functions of a brake control ECU, a drive control ECU, and a steering control ECU. The drive control ECU 40 continuously performs a brake force control of each wheel, an output control of an in-vehicle drive power source, and a steering angle control based on an operation command according to a driving operation of a driver or a control command of the autonomous driving ECU 50.

The HMI control device 20, together with a plurality of display devices 21, an audio device an ambient light, and an operation device and the like, constitute the HMI system. The HMI system has an input interface function of receiving an operation made by an occupant such as a driver of the subject vehicle Am. The HMI system 10 also has an output interface function of presenting information to the occupant such as the driver. The display device 21 visually presents information to the driver by displaying an image and the like. The display device 21 includes a meter display, a center information display (hereinafter referred to as CID), a head-up display (hereinafter referred to as HUD), and the like. The CID has a touch panel function and detects a touch operation to the display screen by the driver or the like.

### (Configuration of Periphery Monitoring System)

The periphery monitoring ECU 100 constitutes a periphery monitoring system 10 together with a plurality of external cameras 130, at least one millimeter wave radar 33, a plurality of sonars 34, and the like. The external camera 130, the millimeter wave radar 33, and the sonar 34 are periphery monitoring sensors that monitor the surrounding environment of the subject vehicle Am. The periphery monitoring system 10 may further include periphery monitoring sensors such as lidar and acoustic sensing systems. The periphery monitoring system 10 can detect moving and stationary objects around the subject vehicle within the detection range of the periphery monitoring sensor. The periphery monitoring system 10 continues to detect objects around the vehicle Am not only during an autonomous driving period when the vehicle Am is driven by the autonomous driving function, but also during a manual driving period when the driver performs the driving operation of the subject vehicle Am. The periphery monitoring system 10 provides recognition information of objects around the subject vehicle to the autonomous driving ECU 50 and the like.

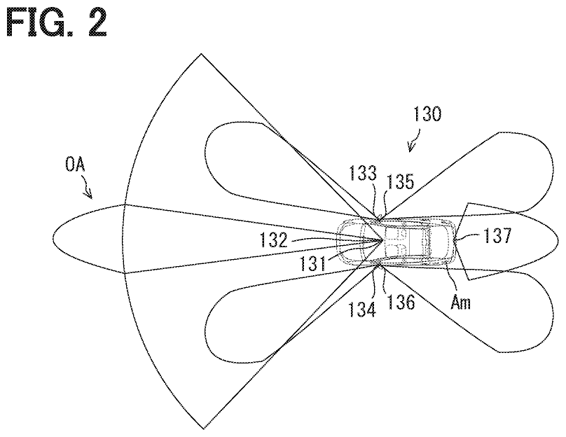

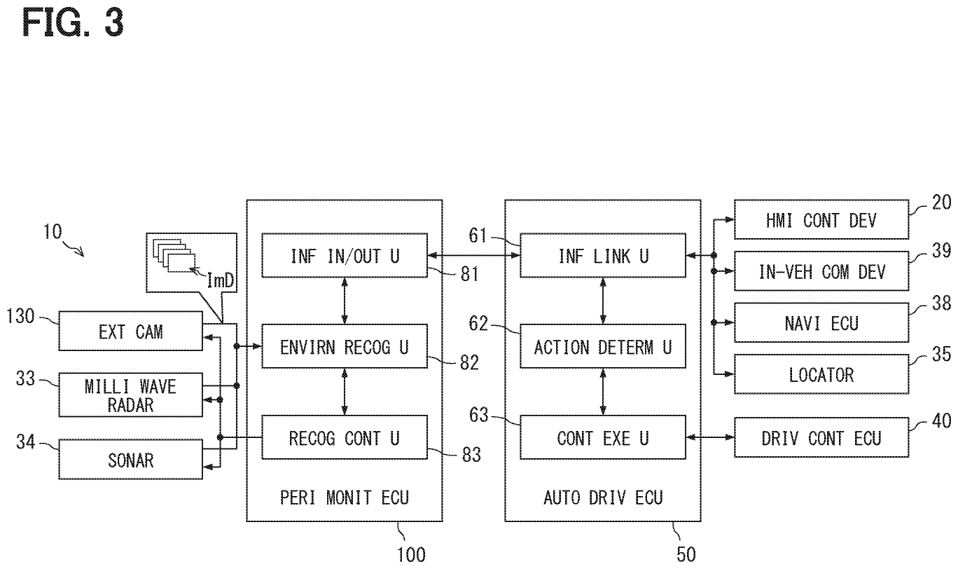

The external camera 130 is an in-vehicle imaging device that captures images of the surroundings of the subject vehicle Am. The external camera 130 provides the periphery monitoring ECU 100 with image data ImD (see FIG. 3) as detection information. The multiple external cameras 130 include a front wide-angle camera 131, a front telephoto camera 132, a right front side camera 133, a left front side camera 134, a right rear side camera 135, a left rear side camera 136, and a rear camera 137 (see FIG. 2).

The front wide-angle camera 131 and the front telephoto camera 132 are attached to the subject vehicle Am so as to capture images ahead of the subject vehicle Am (in the traveling direction). The front wide-angle camera 131 has a lens with a wider angle of view than the front telephoto camera 132 and can capture a wide range of images ahead of the vehicle. The front telephoto camera 132 has a lens with a narrower angle of view than the front wide-angle camera 131, and is able to capture detailed images of distant targets.

The right front side camera 133 is attached to the subject vehicle Am so as to capture an image of the right front side of the subject vehicle Am. The left front side camera 134 is attached to the subject vehicle Am so as to capture an image of the left front side of the subject vehicle Am. The right rear side camera 135 is attached to the subject vehicle Am so as to capture an image of the right rear side of the subject vehicle Am. The left rear side camera 136 is attached to the subject vehicle Am so as to capture an image of the left rear side of the subject vehicle Am. The rear camera 137 is attached to the subject vehicle Am so as to capture images of the area behind the subject vehicle Am.

The periphery monitoring ECU 100 functions as a sensor control device and comprehensively controls the recognition of the driving environment by a plurality of external cameras 130, millimeter-wave radar 33, sonar 34, and the like. The periphery monitoring ECU 100 is a computer that mainly includes a control circuit that includes a processing unit 11, a RAM 12, a storage unit 13, an input/output interface 14, and a bus that connects these components. The processing unit 11 accesses the RAM 12 to execute various processes (i.e., instructions) for realizing the vehicle control method (e.g., sensor control method and environment recognition method) of the present disclosure. The storage unit 13 stores various vehicle control programs (e.g., sensor control programs, environment recognition programs) that are executed by the processing unit 11. By executing the program by the processing unit 11, in the periphery monitoring ECU 100, an information input/output unit 81, an environment recognition unit 82, and a recognition control unit 83 and the like (see FIG. 3) are provided as multiple functional units for recognizing the driving environment of the subject vehicle Am.

The information input/output unit 81 is connected to the communication bus 99 and outputs information to the communication bus 99 and acquires information from the communication bus 99. Specifically, the information input/output unit 81 provides information to the autonomous driving ECU 50 and acquires information from the autonomous driving ECU 50. The information input/output unit 81 acquires the recognition information indicating the recognition results of the driving environment around the subject vehicle from the environment recognition unit 82 and provides the acquired recognition information to the autonomous driving ECU 50. The information input/output unit 81 acquires the control state information indicating the operating state of the autonomous driving from the information linkage unit 61, which will be described later. The information input/output unit 81 acquires the locator information and map data generated by the locator 35, the route information generated by the navigation ECU 38, the detection information received by the in-vehicle communication device 39, and the vehicle speed information generated by the driving control ECU 40, and the like. The information input/output unit 81 provides the acquired information to the environment recognition unit 82.

The environment recognition unit 82 acquires the detection information from the external camera 130, the millimeter wave radar 33, and the sonar 34. The environment recognition unit 82 recognizes the driving environment of the subject vehicle Am by combining the locator information, the map data, the detection information, and the like. The environment recognition unit 82 may acquire the detection information received by the in-vehicle communication device 39 and use the detection information to recognize the driving environment. The environment recognition unit 82 acquires the road information related to the road on which the subject vehicle Am is traveling or is scheduled to travel, based on the locator information, the map data, the route information, and the like. The environment recognition unit 82 grasps the relative positions and relative speeds of dynamic targets around the subject vehicle Am, such as other vehicles traveling around the subject vehicle Am.

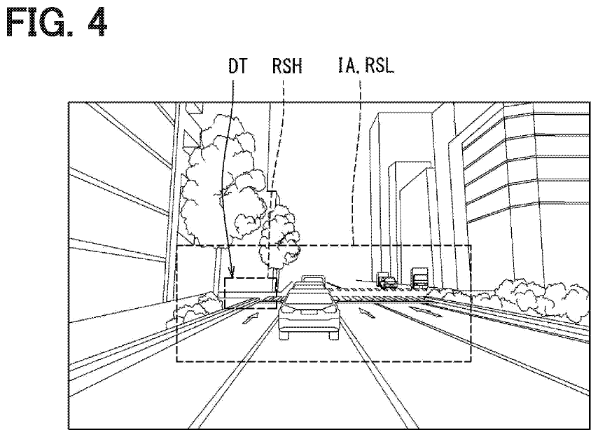

The recognition control unit 83 controls the operation of the external camera 130, the millimeter wave radar 33, and the sonar 34. The recognition control unit 83 sets a high-precision recognition range RSH (see FIG. 4) in a part of the image capturing area IA of the external camera 130. The image capturing area IA is an area within the angle of view captured by the external camera 130. The area captured in each image constituting the image capturing data ImD (see FIG. 3) corresponds to the image capturing area IA. The recognition control unit 83 controls the high-precision recognition range RSH of the external camera 130. The high-precision recognition range RSH is a rectangular portion of the image capturing area IA (see FIG. 4) captured by the external camera 130 that is recognized with higher accuracy than the normal recognition range RSL. High-precision (i.e., high-resolution) recognition enables the environment recognition unit 82 to detect, for example, the flashing of turn signals (i.e., blinker lamps) and hazard lamps, and the illumination of brake lamps, early on and with high precision. The range of the image capturing area IA of the external camera 130 excluding the high-precision recognition range RSH is the normal recognition range RSL. The normal recognition range RSL is recognized with lower accuracy (i.e., lower resolution) than the high accuracy recognition range RSH.

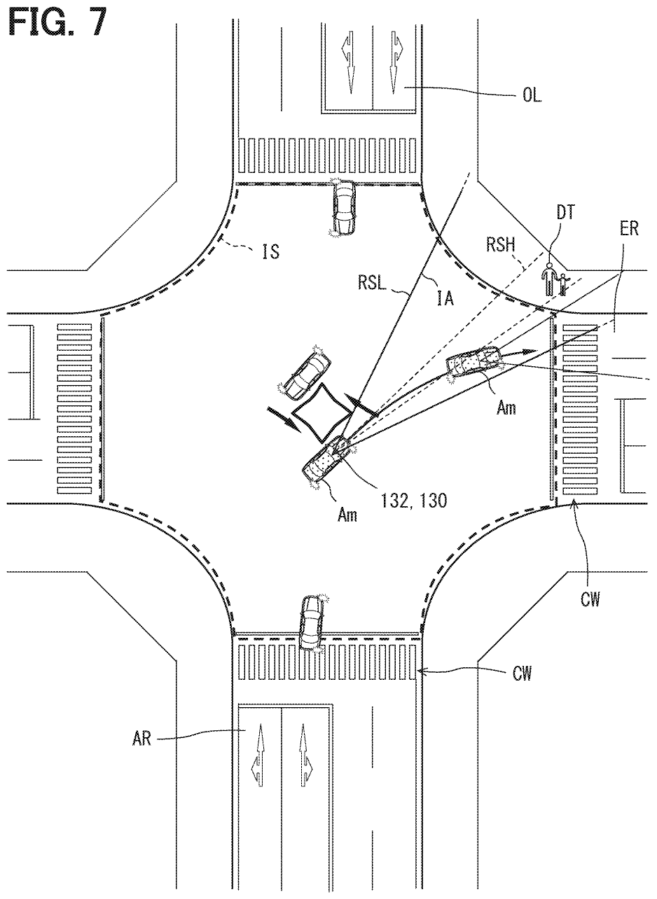

The recognition control unit 83 at least performs control to displace the position of the high-accuracy recognition range RSH in the image capturing area IA from the reference position. The recognition control unit 83 displaces the position of the high-precision recognition range RSH within the image capturing area IA so that the detection target DT is included in the high-precision recognition range RSH. The reference position may be set at the center of the image capturing area IA, or at a location where the detection target DT is likely to be captured by each of the external cameras 130. The reference position may be different for each external camera 130. The detection targets DT include other vehicles around the subject vehicle, a crosswalk CW (see FIG. 7), and pedestrians in the vicinity thereof. The recognition control unit 83 may further be able to control the size of the high-precision recognition range RSH, the number of high-precision recognition ranges RSH that are set, the degree of resolution enhancement of the high-precision recognition range RSH, and the like.

As an example, the recognition control unit 83 applies a low-resolution process for reducing the resolution to an area of the normal recognition range RSL excluding the high-precision recognition range RSH in the image capturing data ImD input from the external camera 130. The recognition control unit 83 executes the image recognition process to extract the detection target DT from the low-resolution normal recognition range RSL. On the other hand, the resolution of the high-precision recognition range RSH is maintained at the same resolution as that of the image capturing data ImD. The recognition control unit 83 executes the image recognition process to extract the detection target DT within the high-precision recognition range RSH in which high resolution is maintained. As a result, the calculation resources of the periphery monitoring ECU 100 are preferentially allocated to target extraction from the high-precision recognition range RSH.

As another example, the recognition control unit 83 changes the ratio of the length of time for the process of detecting the detection target DT between the high-precision recognition range RSH and the normal recognition range RSL, without performing a process of changing the resolution. More specifically, the recognition control unit 83 sets the time allocated to the process of detecting the detection target DT from the high-precision recognition range RSH to be longer than the time allocated to the process of detecting the detection target DT from the normal recognition range RSL. For these reasons, the calculation resources of the periphery monitoring ECU 100 are preferentially allocated to the target detection within the high-precision recognition range RSH.

The high-precision recognition range RSH described above may be set for all of the external cameras 130, or may be set for only some of the external cameras 130. Furthermore, the recognition control unit 83 may control the high-precision recognition ranges RSH of all of the external cameras 130, or may control the high-precision recognition ranges RSH of only some of the external cameras 130.

### (Configuration of the Autonomous Driving ECU)

The autonomous driving ECU 50 is a computer that mainly includes a control circuit that includes a processing unit 51, a RAM 52, a storage unit 53, an input/output interface 54, and a bus that connects these elements. The processing unit 51 accesses the RAM 52 to execute various processes (i.e., instructions) for realizing the autonomous driving control method of the present disclosure. The storage unit 53 stores various programs (such as an autonomous driving control program) to be executed by the processing unit 51. By executing the program by the processing unit 51, in the autonomous driving ECU 50, an information linkage unit 61, an action determination unit 62, and a control execution unit 63 (see FIG. 3) are established as multiple functional units for realizing the autonomous driving function.

The information linkage unit 61 provides information to the HMI control device 20, the periphery monitoring ECU 100, and the like, and acquires information from the HMI control device 20, the locator 35, the navigation ECU 38, the in-vehicle communication device 39, the periphery monitoring ECU 100, and the like. The information linkage unit 61 provides the control state information of the autonomous driving function generated by the action determining unit 62 to the HMI control device 20 and the periphery monitoring ECU 100. The information linkage unit 61 outputs a request to the HMI control device 20 to perform an in-vehicle notification, thereby enabling the HMI control device 20 to provide a notification synchronized with the operation state of the autonomous driving function. Furthermore, the information linkage unit 61 provides the action determining unit 62 with route information acquired from the navigation ECU 38 and recognition information acquired from the periphery monitoring ECU 100 (or the information input/output unit 81).

When the autonomous driving ECU 50 has control of the driving operation, the action determination unit 62 generates a planned driving line along which the subject vehicle Am will travel, based on the results of recognition of the driving environment by the periphery monitoring system 10. The action determination unit 62 generates a planned driving line for making a right or left turn at an intersection IS, for example. The action determination unit 62 outputs the generated planned driving line to the control execution unit 63.

When the autonomous driving ECU 50 has control of the driving operation, the control execution unit 63 cooperates with the driving control ECU 40 to perform acceleration/deceleration control, steering control, and the like of the subject vehicle Am in accordance with the planned driving line generated by the action determination unit 62. Specifically, the control execution unit 63 generates control commands based on the planned driving line and sequentially outputs the generated control commands to the driving control ECU 40.

### (Details of High-Resolution Recognition Range Control at Intersections]

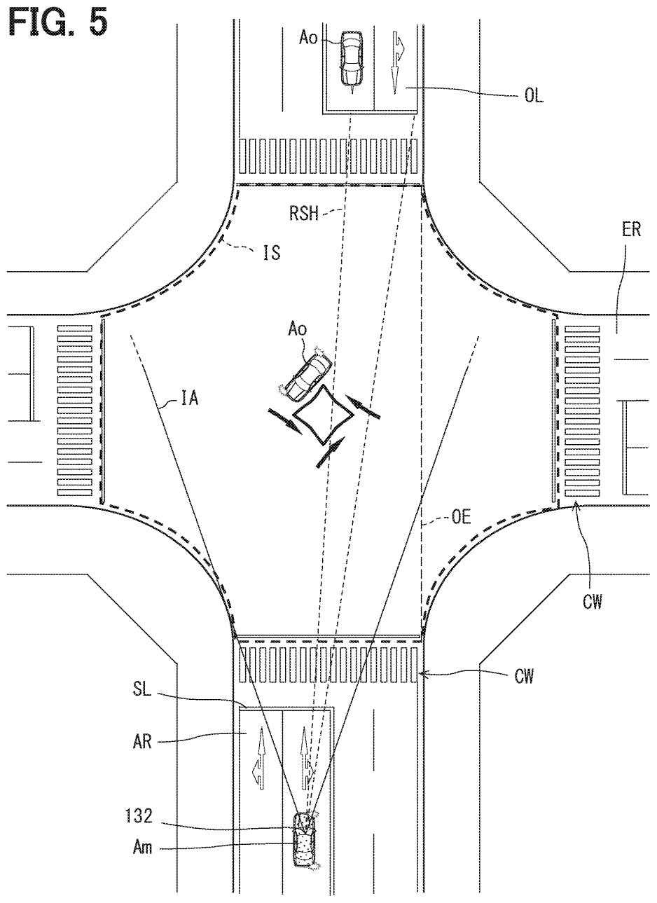

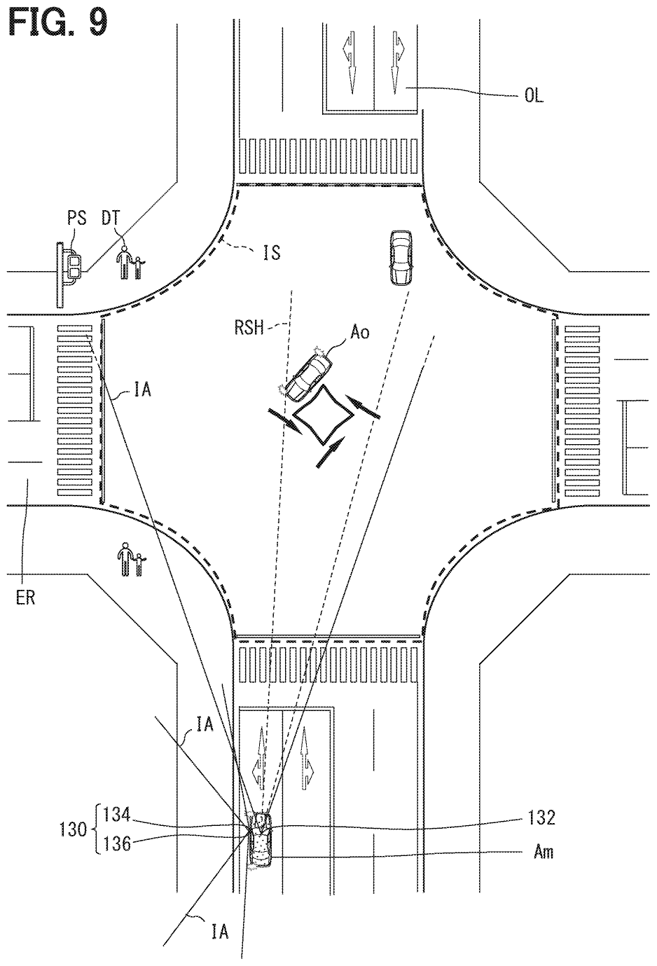

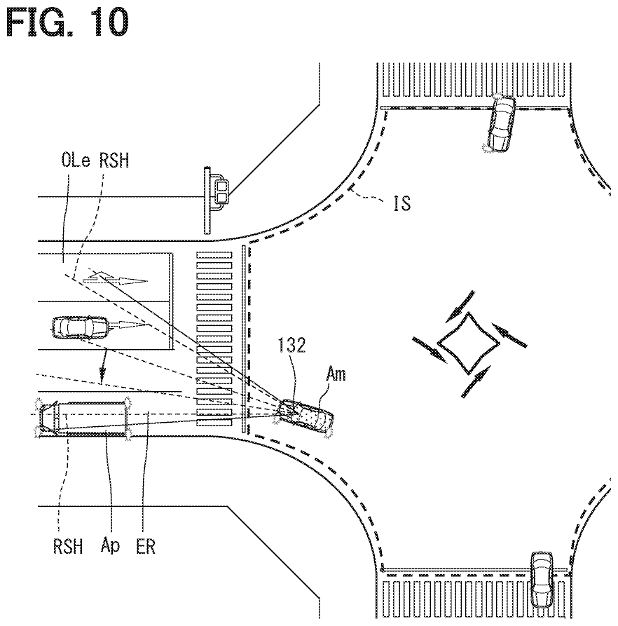

The autonomous driving ECU 50 performs right and left turns at the intersection IS using driving support control at autonomous driving level 2 or autonomous driving control at autonomous driving level 3 or higher. The following description of right and left turns assumes a traffic environment in which vehicles drive on the left side of the road. Therefore, turning right is an intersection driving control in which the vehicle crosses the oncoming lane OL (see FIGS. 5 to 8). On the other hand, turning left is an intersection driving control in which the vehicle does not cross the oncoming lane OL (see FIGS. 9 and 10).

The controls of the present disclosure can also be applied to traffic environments where vehicles drive on the right side of the road. In this case, a left turn is an intersection driving control in which the vehicle crosses the oncoming lane OL, and a right turn is an intersection driving control in which the vehicle does not cross the oncoming lane OL. Therefore, the contents of each control related to a right turn described below can be applied to each control related to a left turn in a traffic environment where vehicles drive on the right side. Similarly, the contents of each control related to a left turn, which will be described later, can be applied to each control related to a right turn in a traffic environment where vehicles drive on the right side.

The periphery monitoring ECU 100 cooperates with the autonomous driving ECU 50 to perform the intersection driving control by the autonomous driving ECU 50. Specifically, the periphery monitoring ECU 100 controls the high-precision recognition range RSH of the external camera 130, and prioritizes the use of calculation resources for detecting dynamic objects that affect the travelling of the subject vehicle Am.

More specifically, the environment recognition unit 82 determines whether a right or left turn is planned at an intersection IS based on route information and the like acquired by the information input/output unit 81. When the subject vehicle Am turns right or left at an intersection IS, the environment recognition unit 82 grasps the positional relationship between the intersection IS and the subject vehicle Am based on the generated recognition information. The environment recognition unit 82 determines whether the positional relationship indicates a situation before entering the intersection IS (hereinafter, before entering the intersection), a situation within the area of the intersection IS (hereinafter, within the intersection area), or a situation after exiting the intersection (hereinafter, after exiting the intersection).

In the following description, the inner edges of the crosswalks CW of each road connected to the intersection IS are defined as the boundaries that define the area of the intersection IS. In other words, the area inside each crosswalk CW is disposed within the intersection area (see dashed line in FIG. 5). The section of the approach road AR to the intersection IS that is disposed just before the crosswalk CW is defined as the section before entering the intersection. The section of the exit road ER from the intersection IS beyond the crosswalk CW is defined as the section after exiting the intersection. The boundaries defining the area before entering the intersection and the area after exiting the intersection may be changed as appropriate. As an example, a section of the approach road AR that is disposed just before the stop line SL may be defined as the section before entering the intersection. Further, the section beyond the outer edge OE of the oncoming lane OL may be defined as the section after exiting the intersection.

The recognition control unit 83 changes the state of the high-precision recognition range RSH, which is recognized with higher accuracy than the normal recognition range RSL within the image capturing area IA captured by the external camera 130, in accordance with the positional relationship with the intersection IS grasped by the environmental recognition unit 82. When changing the state of the high-precision recognition range RSH, the distance to the vehicle external area included in the high-precision recognition range RSH, the direction of the vehicle external area included in the high-precision recognition range RSH, and the size of the vehicle external area included in the high-precision recognition range RSH are changed. The recognition control unit 83 changes the state of the high-precision recognition range RSH corresponding to the situation before entering the intersection, the situation within the intersection area, and the situation after exiting the intersection, respectively.

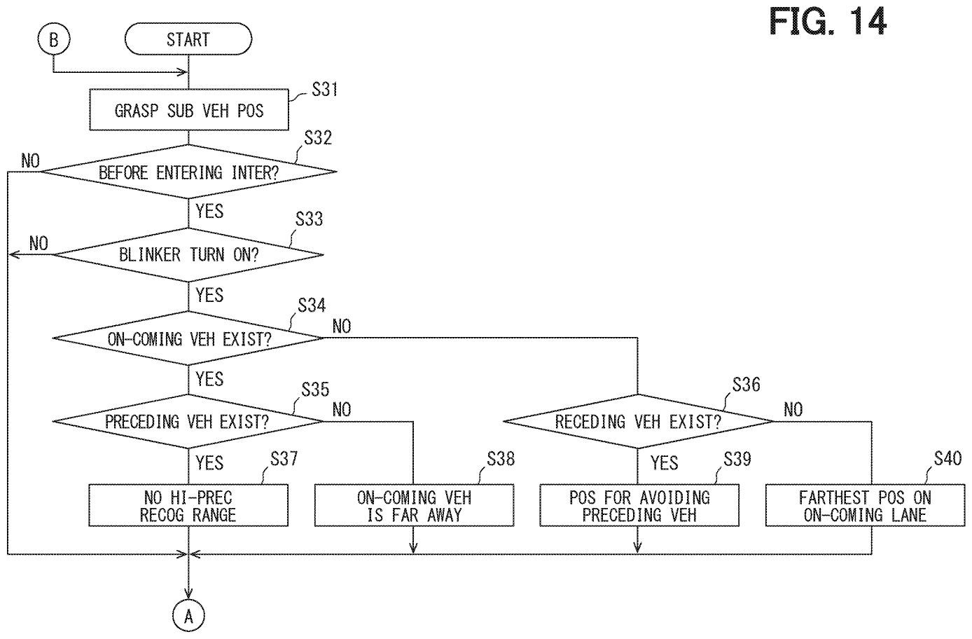

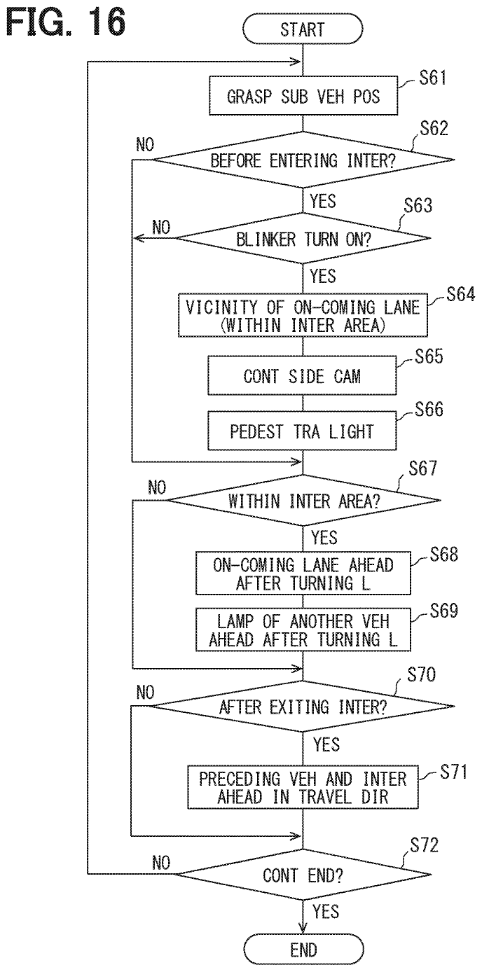

While traveling on the approach road AR toward an intersection IS where a right or left turn is to be made, the recognition control unit 83 starts controlling the state of the high-precision recognition range RSH corresponding to a right or left turn based on the start of the flashing operation of the blinker. During the autonomous driving period, the autonomous driving ECU 50 generates a trigger to activate the blinker. During the manual driving period, the body ECU or the like generates a trigger to activate the blinker based on the input operation of the driver. The trigger for activating the blinker is acquired by the information input/output unit 81 and is used as a trigger for starting the state control by the recognition control unit 83 (see S33 in FIG. 14 and S63 in FIG. 16).

The recognition control unit 83 displaces the high-precision recognition range RSH in accordance with the steering angle and traveling speed of the subject vehicle Am. The recognition control unit 83 displaces the high-precision recognition range RSH in the right-left direction (i.e., lateral direction) in conjunction with the steering angle (i.e., steer angle) of the subject vehicle Am. The recognition control unit 83 displaces the high-precision recognition range RSH so as to include the road surface further in the traveling direction (i.e., oncoming lane OL) as the traveling speed of the subject vehicle Am increases.

The recognition control unit 83 changes the state of the high-precision recognition range RSH of the front telescope camera 132 with the longest focal length among the multiple external cameras 130 facing the forward of the subject vehicle Am, depending on the positional relationship. Of the front wide-angle camera 131 and front telescope camera 132 facing forward of the subject vehicle Am, the recognition control unit 83 changes the state of the high-precision recognition range RSH of only the front telescope camera 132, and does not change the state of the high-precision recognition range RSH of the front wide-angle camera 131. Furthermore, the high-precision recognition range RSH is not set for the front wide-angle camera 131.

Hereinafter, the details of the control of the high-accuracy recognition range RSH that is performed when the subject vehicle Am makes a right turn or a left turn at the intersection IS will be described based on FIGS. 5 to 10 and with reference to FIGS. 1 to 4.

### (Right Turn at an Intersection: Before Entering the Intersection)

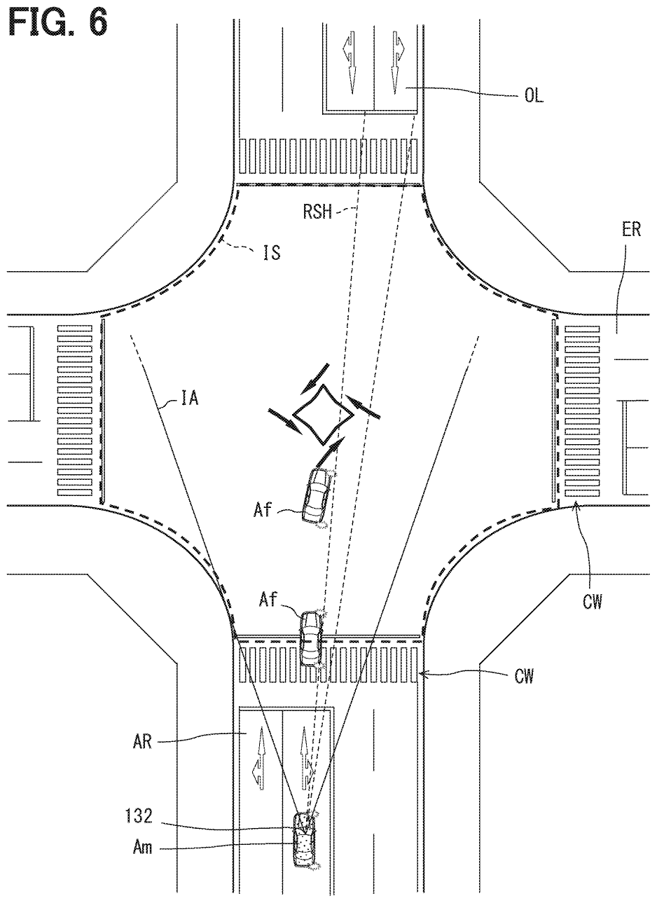

FIGS. 5 to 8 show a right turn scene in which the subject vehicle Am crosses the oncoming lane OL, and the state of control of the high-precision recognition range RSH in a right turn pattern performed in the right turn scene. The environment recognition unit 82 determines whether or not there is an oncoming vehicle Ao (see FIG. 5) and a preceding vehicle Af (see FIG. 6) in a right turn scene. The oncoming vehicle Ao is another vehicle traveling in the opposite direction to the subject vehicle Am and entering the intersection IS from the oncoming lane OL. The oncoming vehicle Ao may be a vehicle going straight through the intersection IS, or may be a vehicle making a right or left turn at the intersection IS. A scene may occur in which there are multiple types of oncoming vehicles Ao, in other words, multiple straight-travelling vehicles, multiple right-turning vehicles, and multiple left-turning vehicles included in the oncoming vehicles Ao. The preceding vehicle Af is another vehicle traveling ahead of the subject vehicle Am, which enters the intersection IS before the subject vehicle Am and makes a right turn.

The recognition control unit 83 starts controlling the state of the high-precision recognition range RSH corresponding to the right turn scene based on the start of the flashing operation of the right turn blinker. When the subject vehicle Am makes a right turn at an intersection IS, the recognition control unit 83 sets the high-precision recognition range RSH so that the oncoming lane OL beyond the intersection IS is included in the high-precision recognition range RSH while the subject vehicle Am is traveling in the right-turn lane before entering the intersection.

When an oncoming vehicle Ao exists at the intersection IS (see FIG. 5), the recognition control unit 83 sets the high-precision recognition range RSH so as to include the oncoming lane OL beyond the oncoming vehicle Ao in the high-precision recognition range RSH while avoiding the oncoming vehicle Ao within the intersection area. On the other hand, when there is no oncoming vehicle Ao at the intersection IS, the recognition control unit 83 sets the high-precision recognition range RSH so as to include the farthest part of the recognizable range of the oncoming lane OL in the high-precision recognition range RSH. As an example, the recognition control unit 83 arranges the high-precision recognition range RSH so that the forward vanishing point on the oncoming lane OL side is disposed at the center of the high-precision recognition range RSH. As a result of the above, when there is no oncoming vehicle Ao, the high-precision recognition range RSH is shifted toward the upper edge of the image in the image capturing area IA (see FIG. 4) compared to when there is an oncoming vehicle Ao, and is set to a position suitable for detecting oncoming vehicles Ao disposed far from the subject vehicle.

When a preceding vehicle Af exists (see FIG. 6), the recognition control unit 83 sets the high-precision recognition range RSH so as to avoid the preceding vehicle Af and include the oncoming lane OL beyond the intersection IS in the high-precision recognition range RSH. On the other hand, when there is no preceding vehicle Af, the recognition control unit 83 sets the high-precision recognition range RSH to include the farthest recognizable range of the oncoming lane OL in the high-precision recognition range RSH, similar to the situation when there is no oncoming vehicle Ao. As a result of the above, when there is no preceding vehicle Af, the high-precision recognition range RSH is shifted toward the upper edge of the image in the image capturing area IA (see FIG. 4) compared to the situation when there is a preceding vehicle Af, and is set to a position suitable for detecting a oncoming vehicle Ao disposed far from the subject vehicle.

When neither an oncoming vehicle Ao nor a preceding vehicle Af exists, the recognition control unit 83 sets the high-precision recognition range RSH to include the entire road surface of the section of which the image can be captured in the oncoming lane OL beyond the intersection IS in the high-precision recognition range RSH. On the other hand, when both an oncoming vehicle Ao and a preceding vehicle Af exist, the recognition control unit 83 stops setting the high-precision recognition range RSH before entering the intersection. That is, in the period before entering the intersection, the high-precision recognition range RSH is not set in the image capturing area IA of the front telescope camera 132, and the entire image capturing area IA is set as the normal recognition range RSL.

### (Right Turn at an Intersection: Within the Intersection Area)

When the subject vehicle Am reaches a position within the intersection area that extends beyond the oncoming lane OL, the recognition control unit 83 sets a high-precision recognition range RSH to include a target moving toward a crosswalk CW located at the exit of the intersection for the subject vehicle Am in the high-precision recognition range RSH. Specifically, the recognition control unit 83 sets a pedestrian crossing the crosswalk CW, a pedestrian moving on the sidewalk toward the crosswalk CW, and the like as the detection target DT (see FIG. 7), and arranges a high-precision recognition range RSH at a crosswalk-related position that includes the detection target DT. If the detection target DT is not detected within the high-precision recognition range RSH, the recognition control unit 83 expands the high-precision recognition range RSH in the horizontal direction so that the crosswalk CW captured in the image capturing area IA has a uniform resolution.

When a preceding vehicle Af exists in front of the subject vehicle Am within the intersection area, the recognition control unit 83 sets a plurality of high-precision recognition ranges RSH at positions that avoid the preceding vehicle Af. Specifically, the recognition control unit 83 sets one high-precision recognition range RSH on each of the left and right sides of the preceding vehicle Af, and causes each high-precision recognition range RSH to follow the detection target DT.

If there are multiple right-turn or left-turn lanes at the intersection IS, the environment recognition unit 82 determines whether there are any adjacent vehicles turning right or left in the same direction as the subject vehicle Am at the intersection IS. When there is an adjacent vehicle turning right or left in the same direction as the subject vehicle Am and the image of this adjacent vehicle is captured within the field of view of the front telescope camera 132, the recognition control unit 83 sets a high-precision recognition range RSH on the opposite side of the adjacent vehicle within the intersection area. When an adjacent vehicle exists in the right-turn lane on the left (i.e., outside) side of the subject vehicle Am in a right-turn scene, the recognition control unit 83 shifts the high-precision recognition range RSH to the right of the adjacent vehicle. When an adjacent vehicle exists in the left turn lane to the right (i.e., outside) of the subject vehicle Am in a left turn scene, the recognition control unit 83 shifts the high-precision recognition range RSH to the left of the adjacent vehicle.

### (Right Turn at an Intersection: After Exiting the Intersection)

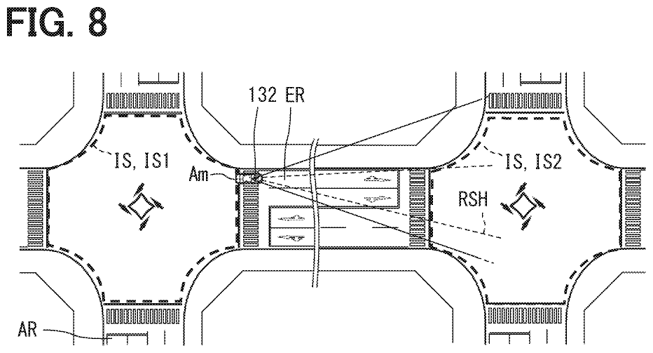

After exiting the intersection IS where the subject vehicle Am made a right turn (hereinafter referred to as the first intersection IS1), the recognition control unit 83 sets the high-precision recognition range RSH to include the next intersection IS (hereinafter referred to as the second intersection IS2) located in the direction of travel of the subject vehicle Am (see FIG. 8). The recognition control unit 83 adjusts the position of the high-precision recognition range RSH so that the high-precision recognition range RSH includes the road surface within the intersection area of the second intersection IS2, the crosswalk CW just before the second intersection IS2, and the traffic lights installed at the second intersection IS2.

### (Left Turn at an Intersection: Before Entering the Intersection)

FIGS. 9 and 10 show a scene in which the subject vehicle Am makes a left turn, and the state of control of the high-precision recognition range RSH in a left turn pattern performed in the left turn scene. The recognition control unit 83 starts controlling the state of the high-precision recognition range RSH corresponding to the left turn scene based on the start of the flashing operation of the left turn blinker.

When the subject vehicle Am makes a left turn at an intersection IS, the recognition control unit 83 sets a high-precision recognition range RSH near the oncoming lane OL at the intersection IS while the subject vehicle Am is traveling in the left-turn lane before entering the intersection (see FIG. 9). This makes it easier for the environment recognition unit 82 to detect an oncoming vehicle Ao that is entering the intersection IS from the oncoming lane OL and turning right at the intersection IS.

When the subject vehicle Am approaches an intersection IS, the recognition control unit 83 sets a high-precision recognition range RSH in each image capturing area IA of the external camera 130 on the sidewalk side, i.e., the left front side camera 134 and the left rear side camera 136, to check for collisions when turning left. When the recognition control unit 83 sets a high-precision recognition range RSH for the left front side camera 134 and the left rear side camera 136, the recognition control unit 83 stops setting the high-precision recognition range RSH for the front telescope camera 132 and reduces the detection load of the front telescope camera 132.

When the subject vehicle Am approaches the intersection IS further, the recognition control unit 83 again sets the high-precision recognition range RSH in the image capturing area IA of the front telescope camera 132. The recognition control unit 83 arranges the high-precision recognition range RSH so as to include the pedestrian traffic light PS. The environment recognition unit 82 grasps the state of the pedestrian traffic light PS from the high-precision recognition range RSH and estimates the movement of the detection target DT (i.e., pedestrian, and the like) near the crosswalk CW.

### (Left Turn at an Intersection: Within the Intersection Area)

The recognition control unit 83 sets the high-precision recognition range RSH within the intersection area so as to include the oncoming lane OLe of the exit road ER to which the vehicle is to turn left (see FIG. 10). In addition, if there are multiple lanes on the exit road ER, the recognition control unit 83 sets the high-precision recognition range RSH so that other vehicles on the exit road ER are included. The recognition control unit 83 adjusts the high-precision recognition range RSH to the lights of other vehicles, specifically, turn signals, hazard lights, brake lights, and the like.

The environment recognition unit 82 determines whether another vehicle ahead of the subject vehicle Am on the exit road ER is a parked vehicle Ap or a stopped vehicle temporarily stopped at the end of a line of vehicles, based on whether the hazard lights are flashing and whether the brake lights are turned on. If the hazard lamps are flashing, the environment recognition unit 82 determines that the other vehicle on the exit road ER is a parked vehicle Ap that will not immediately starts moving. On the other hand, if the brake lights are turned on, the environment recognition unit 82 determines that the other vehicle on the exit road ER is a stopped vehicle that is temporarily stopped. Furthermore, the environment recognition unit 82 estimates whether or not another vehicle on the exit road ER is changing a traffic lane based on whether or not the blinker is flashing.

### (Left Turn at an Intersection: After Exiting the Intersection)

After exiting the first intersection IS1 where the subject vehicle has made a left turn, the recognition control unit 83 shifts the high-precision recognition range RSH toward the upper edge of the image in the image capturing area IA, similar to the right-turn scene. The recognition control unit 83 sets the high-precision recognition range RSH so as to include the next second intersection IS2 that exists in the traveling direction after turning left. The recognition control unit 83 adjusts the position of the high-precision recognition range RSH so that the high-precision recognition range RSH includes the road surface within the intersection area of the second intersection IS2, the crosswalk CW just before the second intersection IS2, and the traffic lights installed at the second intersection IS2.

### (Scene of Successive Right and Left Turns at Multiple Intersections)

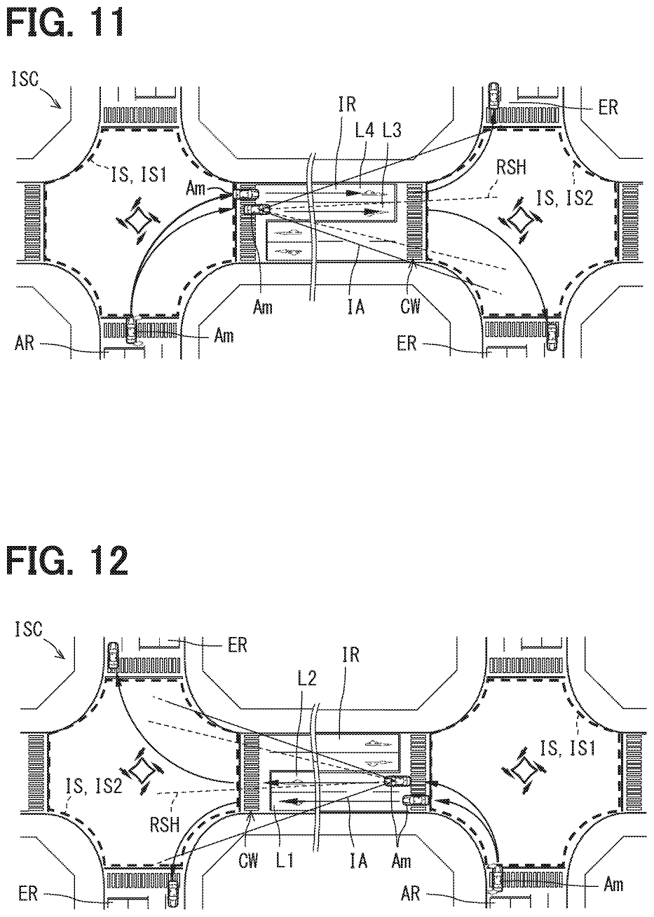

In the right and left turn scenes shown in FIGS. 11 and 12, the subject vehicle Am makes successive right and left turns at a plurality of (e.g., two) intersections IS. The environment recognition unit 82 determines, based on the route information and the like acquired by the information input/output unit 81, whether or not the vehicle is scheduled to make successive right and left turns at a plurality of intersections IS. As an example, if the distance between intersections IS, i.e., the distance between the centers of the first intersection IS1 and the second intersection IS2, is approximately 150 to 300 meters, the environment recognition unit 82 determines that the first intersection IS1 and the second intersection IS2 are consecutive intersections ISC.

When successive right and left turns are planned at a first intersection IS1 and a second intersection IS2 that is entered after exiting the first intersection IS1, the recognition control unit 83 controls the state of the high-precision recognition range RSH corresponding to the right and left turn scene at the consecutive intersections ISC. The recognition control unit 83 determines the pattern of right and left turns to be made at the consecutive intersections ISC. The recognition control unit 83 determines whether a right or left turn at a consecutive intersection ISC is a right turn/right turn pattern in which two right turns are made, a right turn/left turn pattern in which a left turn is made after a right turn, a left turn/left turn pattern in which two left turns are made, or a left turn/right turn pattern in which a right turn is made after a left turn. When successive right and left turns are planned at consecutive intersections ISC, the recognition control unit 83 sets a high-precision recognition range RSH at a position on the intermediate road IR from the first intersection IS1 to the second intersection IS2 after exiting the first intersection IS1, in preparation for turning right or left at the second intersection IS2. In a scene of successive right and left turns at consecutive intersections ISC, the high-precision recognition range RSH is displaced toward the second intersection IS2 near the exit of the first intersection IS1 earlier than in a scene of only one right or left turn.

When the subject vehicle Am is scheduled to travel in a right turn/right turn pattern at the consecutive intersections ISC and the intermediate road IR includes multiple traffic lanes, the autonomous driving ECU 50 causes the subject vehicle Am to enter the right traffic lane L3 of the intermediate road IR when turning right at the first intersection IS1 (see FIG. 11). Before entering the first intersection IS1 and within the area of the first intersection IS1, the recognition control unit 83 adjusts the high-precision recognition range RSH to other vehicles in the right traffic lane L3, which is the exit destination.

When the subject vehicle Am is able to exit into the right lane L3, which is the right traffic turn side, the recognition control unit 83 shifts the high-precision recognition range RSH to the right side of the subject vehicle Am in preparation for turning right at the second intersection IS2. Before entering the second intersection IS2, the recognition control unit 83 performs the state control of the high-precision recognition range RSH in the same manner as in a normal right-turn scene, and adjusts the position of the high-precision recognition range RSH so that the high-precision recognition range RSH includes the crosswalk CW and traffic lights at the second intersection IS2. In a scene of turning right or left at consecutive intersections ISC, the recognition control unit 83 adjusts the position of the high-precision recognition range RSH to include the second intersection IS2 earlier than in a normal (i.e., single) scene of turning right or left.

When the subject vehicle Am is scheduled to make a right/left turn at the consecutive intersections ISC and the intermediate road IR includes multiple traffic lanes, the autonomous driving ECU 50 causes the subject vehicle Am to enter the left traffic lane L4 of the intermediate road IR when turning right at the first intersection IS1 (see FIG. 11). Before entering the first intersection IS1 and within the area of the first intersection IS1, the recognition control unit 83 adjusts the high-precision recognition range RSH to other vehicles and obstacles in the left traffic lane L4, which is the exit destination. When there is another vehicle in the left traffic lane L4, the recognition control unit 83 adjusts the high-precision recognition range RSH to the lights of the other vehicle at the rearmost position.

The environment recognition unit 82 determines whether the aother vehicle at the rearmost position of the left traffic lane L4 is a parked vehicle based on the state of the lights, the position of the vehicle toward the road side, and whether or not people are getting on or off the other vehicle. If the other vehicle at the rearmost position of the left traffic lane L4 is a parked vehicle, the autonomous driving ECU 50 causes the subject vehicle Am to exit into the right traffic lane L3 at the first intersection IS1. In this case, the recognition control unit 83 controls the state of the high-precision recognition range RSH in preparation for moving to the left traffic lane L4 after exiting the first intersection IS1.

On the other hand, if the subject vehicle Am is able to exit into the left traffic lane L4, which is the left turn side, the recognition control unit 83 shifts the high-precision recognition range RSH to the left side of the subject vehicle Am in preparation for turning left at the second intersection IS2. Before entering the second intersection IS2, the recognition control unit 83 performs the state control of the high-precision recognition range RSH in the same manner as in a normal left-turn scene, and adjusts the position of the high-precision recognition range RSH so that the high-precision recognition range RSH includes the crosswalk CW and traffic lights at the second intersection IS2.

When the subject vehicle Am is scheduled to travel in a left turn/left turn pattern at the consecutive intersections ISC and the intermediate road IR includes multiple traffic lanes, the autonomous driving ECU 50 causes the subject vehicle Am to enter the left traffic lane L1 of the intermediate road IR when turning left at the first intersection IS1 (see FIG. 12). Before entering the first intersection IS1 and within the area of the first intersection IS1, the recognition control unit 83 adjusts the high-precision recognition range RSH to other vehicles and obstacles in the left traffic lane L1, which is the exit destination. When there is another vehicle in the left traffic lane L1, the recognition control unit 83 adjusts the high-precision recognition range RSH to the lights of the other vehicle at the rearmost position.

The environment recognition unit 82 determines whether the other vehicle at the rearmost position of the left traffic lane L1 is a parked vehicle based on the state of the lights, the position of the vehicle toward the road side, and whether or not people are getting on or off the other vehicle. If the other vehicle at the rearmost position of the left traffic lane L1 is a parked vehicle, the autonomous driving ECU 50 causes the subject vehicle Am to exit into the right traffic lane L2 at the first intersection IS1. In this case, the recognition control unit 83 controls the state of the high-precision recognition range RSH in preparation for moving to the left traffic lane L1 after exiting the first intersection IS1.

On the other hand, if the subject vehicle Am is able to exit into the left traffic lane L1, which is the left turn side, the recognition control unit 83 shifts the high-precision recognition range RSH to the left side of the subject vehicle Am in preparation for turning left at the second intersection IS2. Before entering the second intersection IS2, the recognition control unit 83 performs the state control of the high-precision recognition range RSH in the same manner as in a normal left-turn scene, and adjusts the position of the high-precision recognition range RSH so that the high-precision recognition range RSH includes the crosswalk CW and traffic lights at the second intersection IS2.

When the subject vehicle Am is scheduled to make a left/right turn at the consecutive intersections ISC and the intermediate road IR includes multiple traffic lanes, the autonomous driving ECU 50 causes the subject vehicle Am to enter the right traffic lane L2 of the intermediate road IR when turning right at the first intersection IS1 (see FIG. 12). Before entering the first intersection IS1 and within the area of the first intersection IS1, the recognition control unit 83 adjusts the high-precision recognition range RSH to other vehicles in the right traffic lane L2, which is the exit destination.

When the subject vehicle Am is able to exit into the right lane L2, which is the right traffic turn side, the recognition control unit 83 shifts the high-precision recognition range RSH to the right side of the subject vehicle Am in preparation for turning right at the second intersection IS2. Before entering the second intersection IS2, the recognition control unit 83 performs the state control of the high-precision recognition range RSH in the same manner as in a normal right-turn scene, and adjusts the position of the high-precision recognition range RSH so that the high-precision recognition range RSH includes the crosswalk CW and traffic lights at the second intersection IS2.

### (Details of Pattern Setting Process and High-Precision Range Control Process)

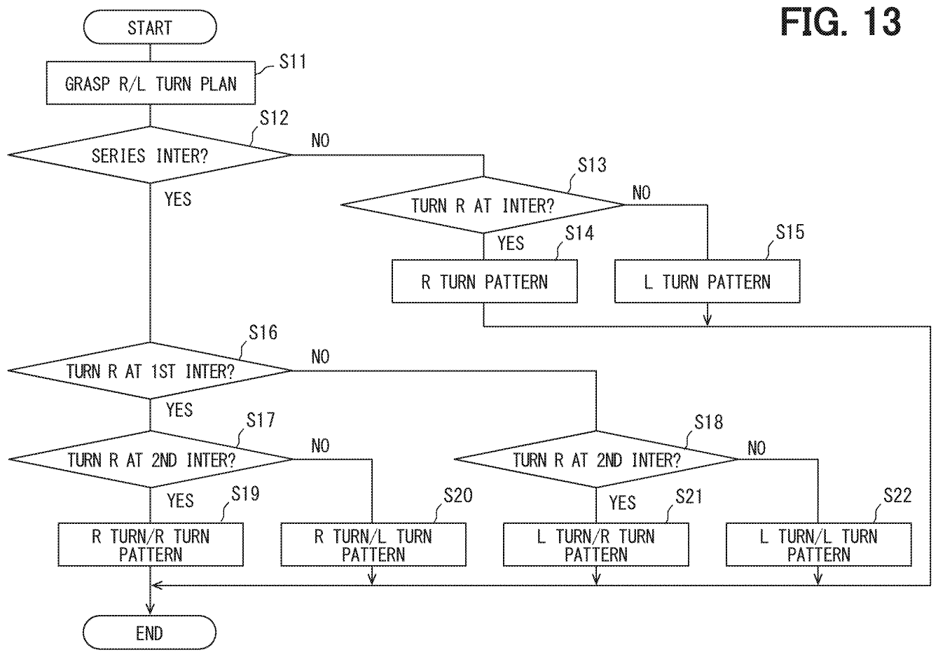

Next, the details of each process for realizing the determination of right and left turn patterns at the intersection IS and the control of the high-precision recognition range RSH described above will be explained below based on FIGS. 13 to 15 and with reference to FIGS. 1 to 12.

### (Pattern Setting Process)

The pattern setting process shown in FIG. 13 is started by the periphery monitoring ECU 100 when the subject vehicle Am approaches an intersection IS at which the subject vehicle Am is to make a right or left turn within a predetermined distance (for example, about 500 meters).

In S11 of the pattern setting process, the recognition control unit 83 determines a driving plan for a right or left turn to be made at an intersection IS ahead of the subject vehicle based on the route information provided to the information input/output unit 81 from the autonomous driving ECU 50 or the navigation ECU 38. In S12, the recognition control unit 83 determines whether or not travel through consecutive intersections ISC is planned.

If travel through consecutive intersections ISC is not planned (i.e., “NO” at S12), the recognition control unit 83 determines in S13 whether a right turn is planned at the next intersection IS. If a right turn is planned at the intersection IS (i.e., “YES” at S13), the recognition control unit 83 sets the state control of the right turn pattern in S14. On the other hand, if a left turn is planned at the intersection IS (i.e., “NO” at S13), the recognition control unit 83 sets the state control of the left turn pattern in S15.

On the other hand, if travel through the consecutive intersections ISC is planned (i.e., “YES” at S12), the recognition control unit 83 determines in S16 whether a right turn is planned at the first intersection IS1. If a right turn is planned at the first intersection IS1 (“YES” at S16), the recognition control unit 83 determines in S17 whether a right turn is planned at the second intersection IS2. If a right turn is planned at the second intersection IS2 (“YES” at S17), the recognition control unit 83 sets the state control of the right turn/right turn pattern in S19. On the other hand, if a left turn is planned at the second intersection IS2 (“NO” at S17), the recognition control unit 83 sets the state control of the right turn/left turn pattern in S20.

If a left turn is planned at the first intersection IS1 (“NO” at S16), the recognition control unit 83 determines in S18 whether a right turn is planned at the second intersection IS2. If a right turn is planned at the second intersection IS2 (“YES” at S18), the recognition control unit 83 sets the state control of the left turn/right turn pattern in S21. On the other hand, if a left turn is planned at the second intersection IS2 (“NO” at S18), the recognition control unit 83 sets the state control of the left turn/left turn pattern in S22.

### (High-Precision Range Control Process: Right Turn Pattern>

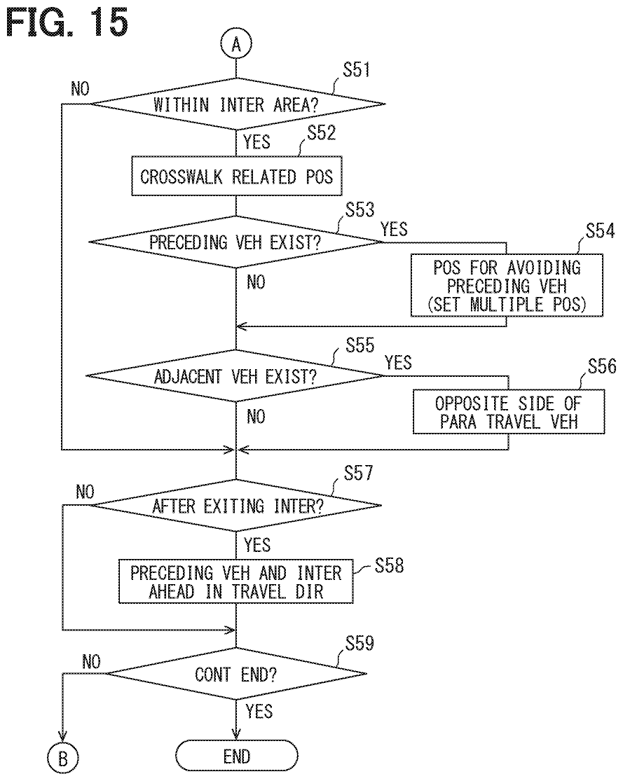

The high-precision range control process shown in FIGS. 14 and 15 is started by the periphery monitoring ECU 100 based on the control mode of the right turn pattern being set in S14 of the pattern setting process (see FIG. 13). In S31 of the high-precision range control process corresponding to the right turn pattern, the environment recognition unit 82 grasps the positional relationship between the intersection IS where the subject vehicle Am will make a right turn and the subject vehicle Am. The environment recognition unit 82 determines whether the positional relationship between the intersection IS and the subject vehicle Am is the situation before entering the intersection, the situation within the intersection area, or the situation after exiting the intersection.

In S32, the environment recognition unit 82 determines whether the position of the subject vehicle Am is disposed before entering an intersection. If the position of the subject vehicle Am is disposed before entering the intersection (“YES” at S32), the information input/output unit 81 determines in S33 whether the right blinker has been turned on based on whether an activation trigger has been acquired. If the right blinker is turned on (“YES” at S33), the environment recognition unit 82 determines whether or not there is an oncoming vehicle Ao and a preceding vehicle Af in S34 to S36.

If both the oncoming vehicle Ao and the preceding vehicle Af exist (“YES” at S34 and “YES” at S35), the recognition control unit 83 cancels setting of the high-precision recognition range RSH of the front telescope camera 132 in S37. If an oncoming vehicle Ao exists but a preceding vehicle Af does not exist (“YES” at S34 and “NO” at S35), the recognition control unit 83 sets the high-precision recognition range RSH in S38 so that the high-precision recognition range RSH includes the oncoming lane OL beyond the oncoming vehicle and beyond the intersection IS.

If there is no oncoming vehicle Ao but a preceding vehicle Af exists (“NO” at S34 and “YES” at S36), the recognition control unit 83 sets the high-precision recognition range RSH in S39 so as to include the oncoming lane OL beyond the intersection IS while avoiding the preceding vehicle Af. If neither the oncoming vehicle Ao nor the preceding vehicle Af exists (“NO” at S34 and “NO” at S36), the recognition control unit 83 sets the high-precision recognition range RSH in S40 to include the farthest recognizable range of the oncoming lane OL.

If the subject vehicle is not disposed before entering an intersection (“NO” at S32) or the blinker is not turned on (“NO” at S33), the environment recognition unit 82 determines in S51 whether the subject vehicle Am is disposed within the intersection area. If the subject vehicle Am is disposed within the intersection area (“YES” at S51), the recognition control unit 83 sets a high-precision recognition range RSH at the crosswalk-related position in S52 so as to include targets moving toward the crosswalk CW.

The environment recognition unit 82 determines whether or not there is a preceding vehicle Af in S53. If a preceding vehicle Af exists (“YES” at S53), the recognition control unit 83 sets a plurality of high-precision recognition ranges RSH at positions that avoid the preceding vehicle Af in S54. If there is no preceding vehicle Af (“NO” at S53), the process of S54 is skipped.

The environment recognition unit 82 determines whether there is an adjacent vehicle in S55. If there are multiple traffic lanes for turning right at the intersection IS and there is an adjacent vehicle (“YES” at S55), the recognition control unit 83 sets a high-precision recognition range RSH on the opposite side of the adjacent vehicle within the intersection area in S56. If there is no adjacent vehicle (“NO” at S55), the process of S56 is skipped.

If the subject vehicle is not disposed within the intersection area (“NO” at S51), the environment recognition unit 82 determines in S57 whether the subject vehicle Am has exited the intersection. If the subject vehicle Am is disposed after exiting the intersection (“YES” at S57), the recognition control unit 83 sets the high-precision recognition range RSH in S58 to include the preceding vehicle Af on the exit route ER and the next intersection IS (i.e., second intersection IS2) in the direction of travel.

If the subject vehicle is not disposed after exiting the intersection (“NO” at S57), the environment recognition unit 82 determines in S59 whether the right turn control at the intersection IS by the autonomous driving ECU 50 has ended. If the right turn control at the intersection IS is still continued (“NO” at S59), the process from S31 and subsequent steps are executed again. On the other hand, if the right turn control at the intersection IS has been ended (“YES” at S59), the high-precision range control process is terminated.

### (High-Precision Range Control Process: Left Turn Pattern)

The high-precision range control process shown in FIG. 16 is started by the periphery monitoring ECU 100 based on the control mode of the left turn pattern being set in S15 of the pattern setting process (see FIG. 13). In S61 of the high-precision range control process corresponding to the left turn pattern, the environment recognition unit 82 grasps the positional relationship between the intersection IS where the subject vehicle Am will make a left turn and the subject vehicle Am. Similar to the process for the right turn pattern, the environment recognition unit 82 determines whether the positional relationship between the intersection IS and the subject vehicle Am is the situation before entering the intersection, the situation within the intersection area, or the situation after exiting the intersection.

In S62, the environment recognition unit 82 determines whether the position of the subject vehicle Am is disposed before entering an intersection. If the position of the subject vehicle Am is disposed before entering the intersection (“YES” at S62), the information input/output unit 81 determines in S63 whether the left blinker has been turned on based on whether an activation trigger has been acquired. If the blinker is turned on (“YES” at S63), the recognition control unit 83 sets a high-precision recognition range RSH in the vicinity of the oncoming lane OL in the intersection IS in S64 (see FIG. 9). Additionally, the recognition control unit 83 sets a high-precision recognition range RSH in each of the image capturing areas IA of the left front side camera 134 and the left rear side camera 136 in S65. Furthermore, in S66, the recognition control unit 83 sets the high-precision recognition range RSH of the front telescope camera 132 so as to include the pedestrian traffic light PS.

If the subject vehicle is not disposed before entering an intersection (“NO” at S62) or the blinker is not turned on (“NO” at S63), the environment recognition unit 82 determines in S67 whether the subject vehicle Am is disposed within the intersection area. If the vehicle Am is disposed within the intersection area (“YES” at S67), the recognition control unit 83 sets the high-precision recognition range RSH in S68 so that the high-precision recognition range RSH includes the oncoming lane OLe of the exit road ER after the left turn (see FIG. 10). Furthermore, in S69, the recognition control unit 83 adjusts the high-precision recognition range RSH to the lights of other vehicles on the exit road ER.

If the subject vehicle is not disposed within the intersection area (“NO” at S67), the environment recognition unit 82 determines in S70 whether the subject vehicle Am has exited the intersection. If the subject vehicle Am is disposed after exiting the intersection (“YES” at S70), the recognition control unit 83 sets the high-precision recognition range RSH in S71 to include the preceding vehicle Af on the exit route ER and the next intersection IS (i.e., second intersection IS2) in the direction of travel.

If the subject vehicle is not disposed after exiting the intersection (“NO” at S70), the environment recognition unit 82 determines in S72 whether the left turn control at the intersection IS by the autonomous driving ECU 50 has ended. If the left turn control at the intersection IS is still continued (“NO” at S72), the process from S61 and subsequent steps are executed again. On the other hand, if the left turn control at the intersection IS has been ended (“YES” at S72), the high-precision range control process is terminated.

### (High-Precision Range Control Process: Right and Left Turn Patterns at Consecutive Intersections)

When a control mode for a right/left turn pattern in which right and left turns are successively performed is set in steps S19 to S22 of the pattern setting process (see FIG. 13), the periphery monitoring ECU 100 performs the high-precision range control process described above in combination.

Specifically, when the control mode of the right turn/right turn pattern is set, the periphery monitoring ECU 100 repeatedly performs the high-precision range control process of the right turn pattern (see FIGS. 14 and 15). When the control mode for the right turn/left turn pattern is set, the periphery monitoring ECU 100 successively performs the high-precision range control process for the right turn pattern (see FIGS. 14 and 15) and the high-precision range control process for the left turn pattern (see FIG. 16). When the control mode of the left turn/left turn pattern is set, the periphery monitoring ECU 100 repeatedly performs the high-precision range control process of the left turn pattern (see FIG. 16). When the control mode for the left turn/right turn pattern is set, the periphery monitoring ECU 100 successively performs the high-precision range control process for the left turn pattern (see FIG. 16) and the high-precision range control process for the right turn pattern (see FIGS. 14 and 15).

### (Details of High-Precision Range Notification)

The HMI control device 20 shown in FIGS. 1 and 3 performs the high-precision range notification during the period when a right or left turn is made at an intersection IS, and notifies the driver of the relative position of the high-precision recognition range RSH (see FIG. 4) set by the recognition control unit 83. The HMI control device 20 performs the high-precision range notification using a display device 21 and an audio device.

If the HUD of the display device 21 is configured to be capable of performing augmented reality display, the relative position of the high-precision recognition range RSH is indicated by a virtual image in the shape of a rectangular frame superimposed on the foreground of the subject vehicle Am. Additionally, an image in the form of a frame indicating the high-precision recognition range RSH superimposed on the image captured by the front telescope camera 132 is displayed on the screen of at least one of the meter display and the CID. Furthermore, a notification sound indicating the presence of the high-precision recognition range RSH is reproduced from a speaker located in the direction in which the high-precision recognition range RSH is disposed relative to the driver.

After performing the high-precision range notification, the HMI control device 20 further performs a response request notification before entering the intersection. The response request notification is a preliminary notification that prompts the driver to determine whether or not it is possible to turn right or left and to respond with the result of that determination. The response request notification is carried out in a scene where the intersection IS is congested and it is difficult for the autonomous driving ECU 50 to make a decision. The HMI control device 20 performs the response request notification by displaying the notification on the screen of the meter display or CID, or by issuing a voice notification through an audio device.

The information input/output unit 81 provides the HMI control device 20 with the position information of the high-precision recognition range RSH for high-precision range notification. In addition, the information input/output unit 81 outputs a request for implementing a response request notification to the HMI control device 20 after the high-precision range notification and before entering the intersection. The position information and implementation request of the high-precision recognition range RSH may be transmitted directly from the information input/output unit 81 to the HMI control device 20, or may be transmitted via a configuration such as the autonomous driving ECU 50.

### (Outline of First Embodiment)

In the first embodiment described so far, when the subject vehicle Am makes a right or left turn at an intersection IS, the state of the high-precision recognition range RSH, which is recognized with high accuracy, is changed depending on the positional relationship between the intersection IS and the subject vehicle Am. Therefore, when turning right or left at an intersection IS, it becomes possible to properly sense the environment around the subject vehicle using an external camera 130.

In addition, in the first embodiment, when the subject vehicle Am makes a right or left turn at an intersection IS, the state of the high-precision recognition range RSH of the front telescope camera 132 with the longest focal length among the multiple external cameras 130 facing forward of the subject vehicle Am is changed depending on the positional relationship. The front telescope camera 132 can capture detailed images of distant lights, pedestrians, and other detection targets DT. Therefore, by changing the state of the high-precision recognition range RSH of the front telescope camera 132, it becomes possible to more appropriately sense the environment around the subject vehicle.

In addition, in the first embodiment, when the subject vehicle Am makes a right or left turn at an intersection IS, the state of the high-precision recognition range RSH is changed only for the front telescope camera 132 out of the multiple external cameras 130 facing forward of the subject vehicle Am. The high-precision recognition range RSH is not set for the front wide-angle camera 131. As described above, the image capturing data ImD of the front wide-angle camera 131 can be accumulated and the accumulated image capturing data ImD can be utilized for various purposes without being restricted by the setting of the high-precision recognition range RSH.

Furthermore, in the first embodiment, the positional relationship between the intersection IS and the subject vehicle Am is grasped as being one of the states before entering the intersection, within the intersection area, and after exiting the intersection. Then, the state of the high-precision recognition range RSH is changed to correspond to the situation before entering the intersection, the situation within the intersection area, and the situation after exiting the intersection, respectively. As described above, the high-precision recognition range RSH can be directed at the detection target DT that is recognized as the most warning target at each timing. As a result, the environmental sensing around the subject vehicle can be performed more appropriately.

In addition, in the first embodiment, when the subject vehicle Am makes a right or left turn across the oncoming lane OL at an intersection IS, the high-precision recognition range RSH is set before entering the intersection IS so as to include an area on the oncoming lane beyond the intersection IS. As a result of the above, it becomes possible to detect early an oncoming vehicle Ao entering the intersection IS from the oncoming lane OL.

In the first embodiment, when an oncoming vehicle Ao exists at the intersection IS, the high-precision recognition range RSH is set so as to include the oncoming lane OL beyond the oncoming vehicle Ao. As a result of the above, it is possible to avoid the nearest oncoming vehicle Ao and to quickly detect another oncoming vehicle Ao entering the intersection IS from the oncoming lane OL.

Furthermore, in the first embodiment, when there is no oncoming vehicle Ao at the intersection IS, the high-precision recognition range RSH is set so as to include the farthest recognizable range of the oncoming lane OL. According to the above, it is possible to detect an oncoming vehicle Ao approaching the intersection IS from a distance at an early stage and determine whether or not it is possible for the subject vehicle to start crossing the oncoming lane OL.

Additionally, in the first embodiment, when there is a preceding vehicle Af traveling ahead of the subject vehicle Am, the high-precision recognition range RSH is set so as to avoid this preceding vehicle Af. As a result of the above, it is possible to quickly detect an oncoming vehicle Ao entering the intersection IS from the oncoming lane OL while avoiding a preceding vehicle Af ahead of the subject vehicle.

In the first embodiment, when there is no preceding vehicle Af traveling ahead of the subject vehicle Am, the high-precision recognition range RSH is set to include the farthest recognizable range of the oncoming lane OL. According to the above, it is possible to detect an oncoming vehicle Ao approaching the intersection IS from a distance at an early stage and determine whether or not it is possible for the subject vehicle to start crossing the oncoming lane OL.

Furthermore, in the first embodiment, when both an oncoming vehicle Ao and a preceding vehicle Af exist, the setting of the high-precision recognition range RSH before entering the intersection is stopped. When both an oncoming vehicle Ao and a leading vehicle Af exist, it becomes difficult to grasp the situation in the oncoming lane OL due to their obstruction. Therefore, it may be desirable to perform control to reduce the detection load of the front telescope camera 132 by canceling the setting of the high-precision recognition range RSH.

Additionally, in the first embodiment, the high-precision recognition range RSH is set so as to include targets within the intersection area that are moving toward the pedestrian crossing CW that is located at the exit of the subject vehicle Am. As a result of the above, it is possible to determine whether or not to start crossing the oncoming lane OL by appropriately considering not only whether or not there is an oncoming vehicle Ao, but also whether or not there is a pedestrian crossing the crosswalk CW.

In the first embodiment, when there is a preceding vehicle Af traveling ahead of the subject vehicle Am, a plurality of high-precision recognition ranges RSH are set at positions that avoid the preceding vehicle Af. In an intersection area, it is difficult to ensure a sufficient inter-vehicle distance from the subject vehicle Am to the preceding vehicle Af, and therefore the preceding vehicle Af may be likely to interfere with detection of the area ahead of the subject vehicle Am. Therefore, by setting a plurality of high-precision recognition ranges RSH so as to avoid the preceding vehicle Af, it becomes possible to grasp the situation ahead of the subject vehicle by looking into both sides of the preceding vehicle Af even in a scene where the preceding vehicle Af is located in the immediate vicinity of the subject vehicle.

Furthermore, in the first embodiment, if there are multiple traffic lanes for turning right or left at an intersection IS, and there is an adjacent vehicle turning right or left in the same direction as the subject vehicle Am at the intersection IS, a high-precision recognition range RSH is set on the opposite side of the adjacent vehicle within the intersection area. In such a scene of turning right or left, it is difficult to detect the side of the adjacent vehicle due to the obstruction of the view of the adjacent vehicle traveling in parallel to the subject vehicle Am. Therefore, by setting the high-precision recognition range RSH on the opposite side of the adjacent vehicle, the calculation resources for detection can be effectively used for sensing the environment around the subject vehicle.

Additionally, in the first embodiment, after exiting the first intersection IS1 where the subject vehicle Am makes its first right or left turn, the high-precision recognition range RSH is set to include the next intersection IS2 located in the direction of travel of the subject vehicle Am. As described above, even if the distance from the first intersection IS1 to the second intersection IS2 is short, the environment recognition unit 82 can quickly grasp the situation at the second intersection IS2.

In addition, in the first embodiment, when successive right and left turns are planned at the first intersection IS1 and the second intersection IS2, the high-precision recognition range RSH is set at a position in preparation for turning right or left at the second intersection IS2 after exiting the first intersection IS1. As described above, even in a scene where a subject vehicle is turning right or left at the consecutive intersections ISC, the environment recognition unit 82 can quickly grasp the situation at the second intersection IS2.

Furthermore, in the first embodiment, the position of the high-precision recognition range RSH set by the recognition control unit 83 is notified to the driver using the display device 21 of the subject vehicle Am or the like. In order to realize such high-precision range notification, the information input/output unit 81 provides the HMI control device 20 with the position information of the high-precision recognition range RSH. The high-precision range notification described above allows the driver to intuitively grasp where the periphery monitoring ECU 100 is monitoring and focusing.

In addition, in the first embodiment, an implementation request for a response request notification to prompt the driver as to whether or not a right or left turn is possible is output to the HMI control device 20 after the start of the high-precision range notification and before entering the intersection. By providing a response request notification based on such an implementation request, even if a situation arises in which the autonomous driving ECU 50 alone cannot determine whether or not the vehicle can start within the intersection area, the driver can make a decision with enough time whether or not the subject vehicle Am can start and input the response.

In the above embodiment, the HMI control device 20 corresponds to the “notification device,” and the display device 21 corresponds to the “information presentation device.” Furthermore, the information input/output unit 81 corresponds to an “information providing unit”, the environment recognition unit 82 corresponds to a “position grasping unit”, and the periphery monitoring ECU 100 corresponds to a “vehicle control device”.

### Second Embodiment

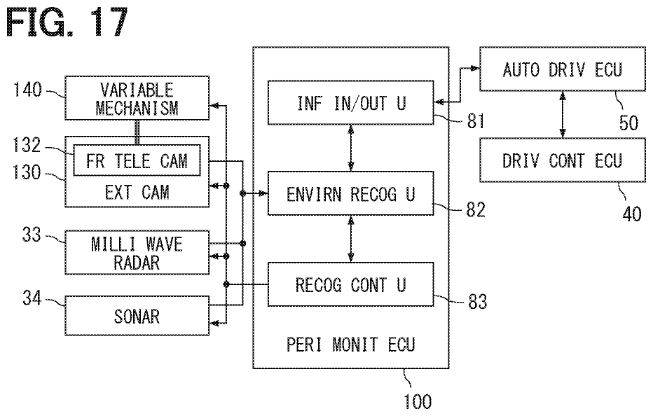

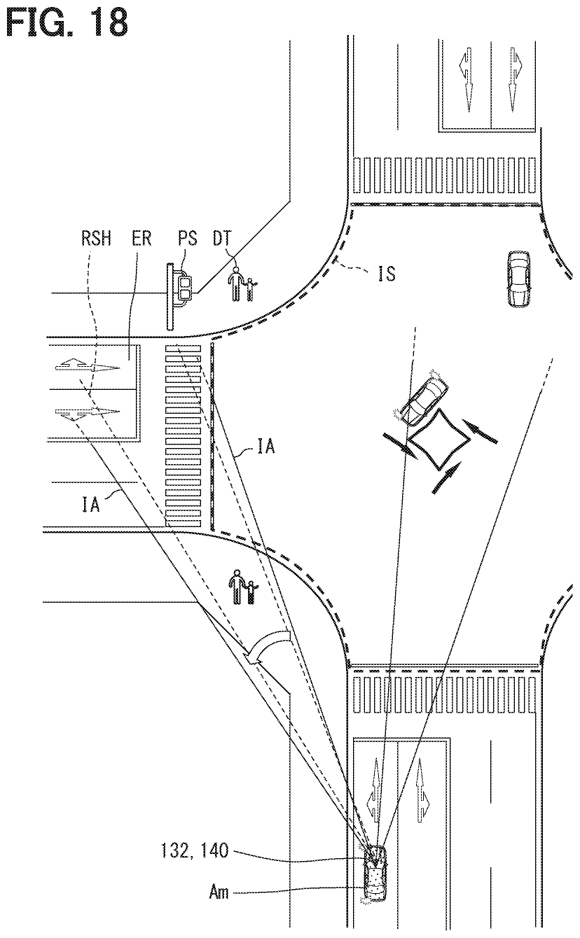

A second embodiment of the present disclosure illustrated in FIGS. 17 and 18 is a modification of the first embodiment. In the second embodiment, at least the front telescope camera 132 of the vehicle external cameras 130 is installed on the subject vehicle Am via a variable mechanism 140. The variable mechanism 140 may be provided in an external camera 130 other than the front telescope camera 132.

The variable mechanism 140 changes the orientation of the front telescope camera 132 in the lateral direction (i.e., left and right direction) based on a control signal input from the recognition control unit 83. The variable mechanism 140 may be configured to be able to change the orientation of the front telescope camera 132 in the vertical direction (i.e., up and down direction). The area outside the vehicle captured in the image capturing area IA of the front telescope camera 132 moves left and right as the front telescope camera 132 swings using the variable mechanism 140.

The recognition control unit 83 combines the mechanical control of the direction of the front telescope camera 132 by the variable mechanism 140 with the software control for moving the high-precision recognition range RSH. That is, the recognition control unit 83 changes the position of the high-precision recognition range RSH in the image capturing area IA by coordinating the hardware control with the software control. As an example, in a scene of turning right at an intersection IS, the recognition control unit 83 shifts the orientation of the front telescope camera 132 to the right using the variable mechanism 140 so that the image capturing area IA of the front telescope camera 132 widely includes the crosswalk CW on the exit road ER. In a left-turn scene at an intersection IS, the recognition control unit 83 shifts the direction of the front telescope camera 132 to the left using the variable mechanism 140 so that the image capturing area IA of the front telescope camera 132 includes the pedestrian traffic light PS and pedestrians near the crosswalk CW (see arrow in FIG. 18).

The second embodiment described so far also achieves the same effect as the first embodiment, and makes it possible to properly sense the environment around the subject vehicle using the external camera 130 when making a right or left turn at an intersection IS. Additionally, in the second embodiment, the recognition control unit 83 and the variable mechanism 140 cooperate to make the image capturing direction of the front telescope camera 132 variable with respect to the subject vehicle Am. As a result, the relative position of the vehicle outside area captured in the high-precision recognition range RSH changes. In this way, by using the variable mechanism 140, even if the angle of view of the front telescope camera 132 is narrow, the area outside the vehicle that can be photographed by the high-precision recognition range RSH of the front telescope camera 132 can be expanded. As a result, the environment recognition unit 82 can use the front telescope camera 132 to detect the detection target DT that exists in a wide range in front with high accuracy.

### Other Embodiments

Although multiple embodiments according to the present disclosure have been described above, the present disclosure is not construed as being limited to the above-mentioned embodiments, and can be applied to various embodiments and combinations within a scope not departing from the spirit of the present disclosure.

In the first modification of the above embodiment, the high-precision recognition range RSH is set for both the front wide-angle camera 131 and the front telescope camera 132, which are front cameras. The recognition control unit 83 changes the state of the high-precision recognition range RSH of the front wide-angle camera 131 and front telescope camera 132 according to the positional relationship between the intersection IS and the subject vehicle Am. In addition, in the second modification of the above embodiment, the high-precision recognition range RSH is set for the front wide-angle camera 131, but the high-precision recognition range RSH is not set for the front telescope camera 132. The recognition control unit 83 changes the state of the high-precision recognition range RSH set only for the front wide-angle camera 131 according to the positional relationship. Furthermore, a high-precision recognition range RSH may be set for both the front wide-angle camera 131 and the front telescope camera 132, which are front cameras, and only the state of the high-precision recognition range RSH of the front telescope camera 132 may be changed depending on the positional relationship.

In the above embodiment, the state control of the high-precision recognition range RSH is switched at each stage: a stage before entering an intersection, a stage within the intersection area, and a stage after exiting the intersection. Such switching of the state control may be performed continuously, rather than stepwise as in the above embodiment. The position at which the state control is switched may also be changed as appropriate.

In the third modification of the above embodiment, the position of the high-precision recognition range RSH within the image capturing area IA is optically movable. The external camera 130 has an optical system capable of forming images with two different resolutions and angles of view. Based on a control signal from the recognition control unit 83, the vehicle external camera 130 shifts the position of the image sensor relative to the optical system, and moves the range on the image sensor where an image with a high resolution angle of view is formed.

In the fourth modification example of the above embodiment, the recognition control unit 83 applies the high-resolution processing or super-resolution processing to increase the resolution of the high-precision recognition range RSH of the image capturing data ImD input from the external camera 130. The recognition control unit 83 executes the image recognition processing to extract the detection target DT from the highly resolved high-precision recognition range RSH. Furthermore, the recognition control unit 83 executes the image recognition processing to extract the detection target DT from the normal recognition range RSL, which remains at a low resolution.

In the fifth modification of the above embodiment, a process for increasing the resolution of the high-precision recognition range RSH and a process for decreasing the resolution of the normal recognition range RSL are combined. In addition, in the sixth modification of the above embodiment, the high-resolution processing is applied to both the high-precision recognition range RSH and the normal recognition range RSL. The high-resolution processing applied to the high-precision recognition range RSH is an image conversion processing that increases the resolution more than the high-resolution processing applied to the normal recognition range RSL. In addition, in the seventh modification of the above embodiment, the low-resolution processing is applied to both the high-precision recognition range RSH and the normal recognition range RSL. The high-resolution processing applied to the normal recognition range RSL is an image conversion processing that lowers the resolution compared to the high-resolution processing applied to the high-precision recognition range RSH.

In the eighth modification of the above embodiment, the function of the periphery monitoring ECU 100 is integrated into the autonomous driving ECU 50. In this eighth modification, the autonomous driving ECU 50 corresponds to the “vehicle control device”, and the information linkage unit 61 corresponds to the “information providing unit”. In addition, in the ninth modification of the above embodiment, the autonomous driving ECU 50 is omitted from the in-vehicle system. The periphery monitoring ECU 100 has the function of a collision damage reduction brake device, and senses the environment around the vehicle during manual driving operation. In a tenth modification example of the above embodiment, the functions of the HMI control device 20 are integrated into the autonomous driving ECU 50. In such a tenth modification, the autonomous driving ECU 50 also corresponds to the “notification device”.

In the above embodiment, the functions provided by the periphery monitoring ECU 100 and the autonomous driving ECU 50, and the like can also be provided by software and hardware that executes the software, software only, hardware only, or a complex combination of the hardware and software. Further, when such functions are provided by electronic circuits as hardware, each function can be provided by a digital circuit including a large number of logic circuits, or an analog circuit. The software for implementing the function may include, at least in part, a code automatically generated by a neural network trained using, for example, real-world camera images or by a language model.

In the foregoing embodiments, each processing unit may include at least one calculation core, such as a central processing unit (CPU) or a graphics processing unit (GPU). The processing unit may further include an FPGA (Field-Programmable Gate Array), a NPU (Neural network Processing Unit), or a IP core having another dedicated function. Additionally, the processing unit is not limited to being a chip configuration in which chips are individually mounted on a printed circuit board. Alternatively, a configuration implemented in an application specific integrated circuit (ASIC), a system on chip (SoC), a chiplet assembly, an FPGA, or the like may correspond to the processing unit.

The form of a storage medium (a non-transitory tangible computer readable medium) that stores various programs and the like may also be appropriately changed. Further, the storage medium is not limited to the configuration provided on the circuit board, and may be provided in the form of a memory card or the like, inserted into a slot portion, and electrically connected to a control circuit such as an autonomous driving ECU 50 or a periphery monitoring ECU 100. Furthermore, the storage medium may be an optical disk, a hard disk drive, a solid state drive, or the like that is a copy source or a distribution source of a program to the autonomous driving ECU 50 or the periphery monitoring ECU 100.

The devices and methods described in the present disclosure may be implemented by a special purpose computer provided by configuring a processor programmed to execute one or more functions embodied by a computer program. Alternatively, the control units and methods described in the present disclosure may be implemented by a dedicated hardware logic circuit. Alternatively, thee control units and methods described in the present disclosure may be implemented by one or more special purpose computers provided by configuring one or more processors that executes a computer program in combination with one or more hardware logic circuits. The computer program may be stored on a computer-readable, non-transitory storage medium as instructions to be executed by a computer.

### Technical Features

This specification discloses multiple technical features described in multiple items listed below. Some features may be described in a multiple dependent form, in which subsequent features alternatively refer to preceding features. Some items may be written in a multiple dependent form referring to another multiple dependent form. The technical idea described in the multiple dependent form defines multiple technical ideas.

### (Technical Feature 1)

A vehicle control device controls at least one external camera (130) that captures an image of a periphery area of a vehicle (Am). The vehicle control device includes: a position grasp unit (82) that grasps a positional relationship between an intersection and the vehicle when the vehicle is to turn right or left at the intersection; and a recognition control unit (83) that changes a state of at least one high-precision recognition range, which is recognized with higher accuracy than a normal recognition range within an image capturing area captured by the at least one external camera, depending on the positional relationship.

### (Technical Feature 2)

In the vehicle control device according to technical feature 1, the at least one external camera includes a plurality of external cameras facing a forward of the vehicle, and the recognition control unit changes the state of the at least one high-precision recognition range of a front telescope camera (132) with a longest focal length among the plurality of external cameras facing the forward of the vehicle in accordance with the positional relationship when the vehicle makes a right or left turn at the intersection.

### (Technical Feature 3)

In the vehicle control device according to technical feature 2, the recognition control unit changes the state of the at least one high-precision recognition range of only a front telescope camera among the plurality of external cameras facing the forward of the vehicle when the vehicle makes a right or left turn at the intersection.

### (Technical Feature 4)

In the vehicle control device according to any one of technical features 1 to 3, the position grasping unit grasps, as the positional relationship, whether a state of the vehicle is in a state before entering the intersection, a state within the intersection area, or a state after exiting the intersection. The recognition control unit changes the state of the at least one high-precision recognition range according to the state of the vehicle which is one of the state before entering the intersection, the state within the intersection area, or the state after exiting the intersection.

### (Technical Feature 5)

In the vehicle control device according to any one of technical features 1 to 4, the recognition control unit sets the at least one high-precision recognition range before entering the intersection so that the at least one high-precision recognition range includes an oncoming lane beyond the intersection when the vehicle makes a right or left turn across the oncoming lane (OL) at the intersection.

### (Technical Feature 6)

In the vehicle control device according to technical feature 5, the recognition control unit sets the at least one high-precision recognition range so as to include the oncoming lane beyond an oncoming vehicle (Ao) when the oncoming vehicle exists at the intersection.

### (Technical Feature 7)

In the vehicle control device according to any one of technical features 5 to 6, the recognition control unit sets the at least one high-precision recognition range to include a farthest recognizable range of the oncoming lane when there is no oncoming vehicle (Ao) at the intersection. (Technical Feature 8)

In the vehicle control device according to any one of technical features 5 to 7, the recognition control unit sets the at least one high-precision recognition range to avoid a preceding vehicle (Af) when the preceding vehicle (Af) traveling in front of the vehicle exists.

### (Technical Feature 9)

In the vehicle control device according to any one of technical features 5 to 8, the recognition control unit sets the at least one high-precision recognition range to include a farthest recognizable range of the oncoming lane when there is no preceding vehicle (Af) traveling in front of the vehicle.

### (Technical Feature 10)

In the vehicle control device according to any one of technical features 5 to 9, the recognition control unit stops setting the at least one high-precision recognition range before entering the intersection when both an oncoming vehicle (Ao) and a preceding vehicle (Af) exist.

### (Technical Feature 11)

In the vehicle control device according to any one of technical features 1 to 10, the recognition control unit sets the at least one high-precision recognition range so as to include a target within the intersection area moving toward a crosswalk (CW) located at an exit destination of the vehicle.

### (Technical Feature 12)

In the vehicle control device according to technical feature 11, the at least one high-precision recognition range includes a plurality of high-precision recognition ranges, and the recognition control unit sets the plurality of high-precision recognition ranges at positions that avoid a preceding vehicle (Af) traveling in front of the vehicle when the preceding vehicle (Af) exists.

### (Technical Feature 13)

In the vehicle control device according to technical feature 11 or 12, the recognition control unit sets the at least one high-precision recognition range on an opposite side of an adjacent vehicle within an intersection area when there are multiple traffic lanes for turning right or left at the intersection and there is the adjacent vehicle turning right or left in a same direction as the vehicle at the intersection.

### (Technical Feature 14)

In the vehicle control device according to any one of technical features 1 to 13, the intersection includes a first intersection (IS1) and a second intersection (IS2) next to the first intersection located in a travelling direction of the vehicle, and the recognition control unit sets the at least one high-precision recognition range to include the second intersection (IS2) after exiting the first intersection.

### (Technical Feature 15)

In the vehicle control device according to any one of technical features 1 to 14, the intersection includes a first intersection (IS1) and a second intersection (IS2) next to the first intersection located in a travelling direction of the vehicle, and the recognition control unit sets the at least one high-precision recognition range to a position prepared for turning right or left at the second intersection after exiting the first intersection when the vehicle plans to make consecutive right or left turns at the first intersection and the second intersection.

### (Technical Feature 16)

The vehicle control device according to any one of technical features 1 to 15, further includes an information providing unit (81) that provides position information of the at least one high-precision recognition range to a notification device (20) for notifying a driver of the vehicle of a position of the at least one high-precision recognition range set by the recognition control unit using an information presentation device (21) of the vehicle.

### (Technical Feature 17)

In the vehicle control device according to technical feature 16, the information providing unit outputs an execution request of notification for prompting the driver to respond whether or not a right or left turn is possible, to the notification device after notifying the position of the high-precision recognition range and before entering the intersection.

### (Technical Feature 18)

A vehicle control program for controlling at least one external camera (130) that captures an image of a periphery area of a vehicle (Am) causes at least one processing unit (11) to execute a process including: grasping a positional relationship between an intersection (IS) and the vehicle when the vehicle is to turn right or left at the intersection (S31, S61); and changing a state of at least one high-precision recognition range (RSH), which is recognized with higher accuracy than a normal recognition range (RSL) within an image capturing area (IA) captured by the at least one external camera, depending on the positional relationship (S38-S40, S52, S54, S56, S58, S64-S66, S68, S69, S71).

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicle control device for controlling at least one external camera that captures an image of a periphery area of a vehicle, the vehicle control device comprising:
at least one of (i) a circuit and (ii) a processor with a memory storing computer program code executable by the processor, the at least one of the circuit and the processor configured to cause the vehicle control device to execute:
grasping a positional relationship between an intersection and the vehicle when the vehicle plans to turn right or left at the intersection; and
changing a state of at least one high-precision recognition range, which is recognized with higher accuracy than a normal recognition range within an image capturing area captured by the at least one external camera, depending on the positional relationship.

2. The vehicle control device according to claim 1, wherein:
the at least one external camera includes a plurality of external cameras facing a forward of the vehicle; and
the at least one of the circuit and the processor is configured to cause the vehicle control device to execute: changing the state of the at least one high-precision recognition range of a front telescope camera with a longest focal length among the plurality of external cameras facing the forward of the vehicle in accordance with the positional relationship when the vehicle makes a right or left turn at the intersection.

3. The vehicle control device according to claim 2, wherein:
the at least one of the circuit and the processor is configured to cause the vehicle control device to execute: changing the state of the at least one high-precision recognition range of only a front telescope camera among the plurality of external cameras facing the forward of the vehicle when the vehicle makes a right or left turn at the intersection.

4. The vehicle control device according to claim 1, wherein:
the at least one of the circuit and the processor is configured to cause the vehicle control device to execute:
grasping, as the positional relationship, whether a state of the vehicle is in a state before entering the intersection, a state within an intersection area, or a state after exiting the intersection; and
changing the state of the at least one high-precision recognition range according to the state of the vehicle which is one of the state before entering the intersection, the state within the intersection area, or the state after exiting the intersection.

5. The vehicle control device according to claim 1, wherein:
the at least one of the circuit and the processor is configured to cause the vehicle control device to execute: setting the at least one high-precision recognition range before entering the intersection so that the at least one high-precision recognition range includes an oncoming lane beyond the intersection when the vehicle makes a right or left turn across the oncoming lane at the intersection.

6. The vehicle control device according to claim 5, wherein:
the at least one of the circuit and the processor is configured to cause the vehicle control device to execute: setting the high-precision recognition range so as to include the oncoming lane beyond an oncoming vehicle when the oncoming vehicle exists at the intersection.

7. The vehicle control device according to claim 5, wherein:
the at least one of the circuit and the processor is configured to cause the vehicle control device to execute: setting the at least one high-precision recognition range to include a farthest recognizable range of the oncoming lane when there is no oncoming vehicle at the intersection.

8. The vehicle control device according to claim 5, wherein:
the at least one of the circuit and the processor is configured to cause the vehicle control device to execute: setting the at least one high-precision recognition range to avoid a preceding vehicle when the preceding vehicle traveling in front of the vehicle exists.

9. The vehicle control device according to claim 5, wherein:
the at least one of the circuit and the processor is configured to cause the vehicle control device to execute: setting the at least one high-precision recognition range to include a farthest recognizable range of the oncoming lane when there is no preceding vehicle traveling in front of the vehicle.

10. The vehicle control device according to claim 5, wherein:
the at least one of the circuit and the processor is configured to cause the vehicle control device to execute: stopping setting the at least one high-precision recognition range before entering the intersection when both an oncoming vehicle and a preceding vehicle exist.

11. The vehicle control device according to claim 1, wherein:
the at least one of the circuit and the processor is configured to cause the vehicle control device to execute: setting the at least one high-precision recognition range so as to include a target within the intersection area moving toward a crosswalk located at an exit destination of the vehicle.

12. The vehicle control device according to claim 11, wherein:
the at least one high-precision recognition range includes a plurality of high-precision recognition ranges; and
the at least one of the circuit and the processor is configured to cause the vehicle control device to execute: setting the plurality of high-precision recognition ranges at positions that avoid a preceding vehicle traveling in front of the vehicle when the preceding vehicle exists.

13. The vehicle control device according to claim 11, wherein:
the at least one of the circuit and the processor is configured to cause the vehicle control device to execute: setting the at least one high-precision recognition range on an opposite side of an adjacent vehicle within an intersection area when there are multiple traffic lanes for turning right or left at the intersection and there is the adjacent vehicle turning right or left in a same direction as the vehicle at the intersection.

14. The vehicle control device according to claim 1, wherein:
the intersection includes a first intersection and a second intersection next to the first intersection located in a travelling direction of the vehicle; and
the at least one of the circuit and the processor is configured to cause the vehicle control device to execute: setting the at least one high-precision recognition range to include the second intersection after exiting the first intersection.

15. The vehicle control device according to claim 1, wherein:
the intersection includes a first intersection and a second intersection next to the first intersection located in a travelling direction of the vehicle; and
the at least one of the circuit and the processor is configured to cause the vehicle control device to execute: setting the at least one high-precision recognition range to a position prepared for turning right or left at the second intersection after exiting the first intersection when the vehicle plans to make consecutive right or left turns at the first intersection and the second intersection.

16. The vehicle control device according to claim 1, wherein:
the at least one of the circuit and the processor is configured to cause the vehicle control device to execute: providing position information of the at least one high-precision recognition range to a notification device for notifying a driver of the vehicle of a position of the at least one high-precision recognition range using an information presentation device of the vehicle.

17. The vehicle control device according to claim 16, wherein:
the at least one of the circuit and the processor is configured to cause the vehicle control device to execute: outputting an execution request of notification for prompting the driver to respond whether or not a right or left turn is possible, to the notification device after notifying the position of the high-precision recognition range and before entering the intersection.

18. The vehicle control device according to claim 1, wherein:
the at least one of the circuit and the processor is configured to cause the vehicle control device to execute:
grasping a positional relationship between an intersection and the vehicle when the vehicle plans to turn right or left at the intersection, as a position grasp unit; and
changing a state of at least one high-precision recognition range, which is recognized with higher accuracy than a normal recognition range within an image capturing area captured by the at least one external camera, depending on the positional relationship as a recognition control unit.

19. A vehicle control method for controlling at least one external camera that captures an image of a periphery area of a vehicle, the vehicle control method causing at least one processing unit to execute a process including:
grasping a positional relationship between an intersection and the vehicle when the vehicle plans to turn right or left at the intersection; and
changing a state of at least one high-precision recognition range, which is recognized with higher accuracy than a normal recognition range within an image capturing area captured by the at least one external camera, depending on the positional relationship.

20. A non-transitory computer readable storage medium comprising instructions being executed by a computer, the instructions including a computer-implemented method for controlling at least one external camera that captures an image of a periphery area of a vehicle, the instructions including:
grasping a positional relationship between an intersection and the vehicle when the vehicle plans to turn right or left at the intersection; and
changing a state of at least one high-precision recognition range, which is recognized with higher accuracy than a normal recognition range within an image capturing area captured by the at least one external camera, depending on the positional relationship.
